(19) United States
(12) Patent Application Publication
(10) Pub. No.: US 2020/0033842 A1
(43) Pub. Date: Jan. 30, 2020

(54) GRINDING QUALITY ESTIMATION MODEL GENERATING DEVICE, GRINDING QUALITY ESTIMATING DEVICE, POOR QUALITY FACTOR ESTIMATING DEVICE, GRINDING MACHINE OPERATION COMMAND DATA ADJUSTMENT MODEL GENERATING DEVICE, AND GRINDING MACHINE OPERATION COMMAND DATA UPDATING DEVICE

(71) Applicant: JTEKT Corporation, Osaka-shi (JP)

(72) Inventors: Yuki MASUDA, Nagoya-shi (JP); Toru KAWAHARA, Chita-gun (JP); Shinji MURAKAMI, Toyota-shi (JP)

(73) Assignee: JTEKT Corporation, Osaka-shi (JP)

(21) Appl. No.: 16/517,890

(22) Filed: Jul. 22, 2019

(30) Foreign Application Priority Data
Jul. 25, 2018 (JP) 2018-139210
Sep. 20, 2018 (JP) 2018-175569
Feb. 4, 2019 (JP) 2019-018312
Feb. 11, 2019 (JP) 2019-022199

(51) Int. Cl. G05B 19/418; G06N 20/00

(52) U.S. Cl. CPC G05B 19/41875; G06N 20/00; G05B 19/4183

(57) ABSTRACT

A grinding quality estimation model generating device includes a measured data acquiring unit configured to acquire measured data in a predetermined period for each of a plurality of workpieces, the measured data being data measured when grinding of the workpiece is performed using a grinding wheel in a grinding machine, and the measured data being at least one of first measured data indicating a state of a structural member of the grinding machine and second measured data associated with a grinding region; and a first learning model generating unit configured to generate a first learning model for estimating grinding quality of the workpiece by machine learning using the measured data associated with the plurality of workpieces as first learning input data.

### INCORPORATION BY REFERENCE

The disclosure of Japanese Patent Application No. 2019-022199 filed on Feb. 11, 2019, and Japanese Patent Application No. 2018-175569 filed on Sep. 20, 2018, each including the specification, drawings and abstract, is incorporated herein by reference in its entirety.

### BACKGROUND

### 1. Technical Field

The disclosure relates to a grinding quality estimation model generating device, a grinding quality estimating device, a poor quality factor estimating device, a grinding machine operation command data adjustment model generating device, and a grinding machine operation command data updating device.

### 2. Description of Related Art

When a workpiece is ground using a grinding wheel in a grinding machine, grinding quality of the workpiece is required to satisfy predetermined conditions. For example, it is necessary to prevent an affected layer from being formed in a workpiece, to cause surface quality (for example, surface roughness) of a workpiece to be less than a predetermined value, and to prevent chatter marks from being formed on a workpiece.

An operator determines whether grinding quality satisfies predetermined conditions by inspecting a ground workpiece and determines that the workpiece is a non-defective product when the predetermined conditions are satisfied. In Japanese Unexamined Patent Application Publication No. 2013-129028 (JP 2013-129028 A), it is described that it is determined whether an affected layer is formed in a workpiece based on a grinding load which is measured when grinding is performed.

In grinding of a workpiece using a grinding wheel in a grinding machine, truing and dressing of the surface of the grinding wheel are performed to maintain sharpness of the grinding wheel. When the sharpness of a grinding wheel decreases, there is a possibility that quality of a workpiece may decrease. Therefore, truing and dressing are performed every time the number of workpieces that have been ground reaches a predetermined number, and the predetermined number is determined such that the quality of a workpiece does not decrease. However, since the predetermined number is determined by an operator, there is a possibility that grinding may continue to be performed even when the sharpness decreases, and there is a possibility that the quality of a workpiece may decrease.

Therefore, in Japanese Unexamined Patent Application Publication No. 2002-307304 (JP 2002-307304 A), it is described that vibration of a spindle head is detected by a vibration detector attached to the spindle head and grinding work is stopped and dressing is performed on a grinding wheel after the amplitude of a spindle reaches a set value that is set in advance based on grinding accuracy of a grinding surface of a workpiece.

With recent increases in computer processing speeds, artificial intelligence has developed quickly. For example, in Japanese Unexamined Patent Application Publication No. 2017-164801 (JP 2017-164801 A), it is described that laser processing condition data is generated by machine learning.

### SUMMARY

However, as described in JP 2013-129028 A, it is not possible to accurately determine whether there is an affected layer by using only a grinding load. This is because there are various factors that cause an affected layer to be formed. Among the factors, some can be easily measured using sensors or easily acquired from devices, and others cannot be easily measured. Therefore, it is necessary to acquire, for determining grinding quality of a workpiece, for example, data as to whether there is an affected layer in consideration of various factors. Further, it is necessary to acquire grinding conditions that make it possible to obtain good grinding quality of a workpiece.

As described in JP 2002-307304, sharpness of a grinding wheel cannot be sufficiently determined only by determining whether vibration of a spindle head has reached a set value. As a result, it is not possible to appropriately determine the timing at which correction (truing and dressing) of a grinding wheel should be performed. Therefore, it is necessary to determine surface quality of the grinding wheel using more information in addition to instantaneous vibration information.

The disclosure provides a grinding quality estimation model generating device that can acquire grinding quality of a workpiece, and a grinding quality estimating device that can estimate grinding quality of a workpiece. The disclosure also provides a poor quality factor estimating device that can estimate a factor causing poor quality of a workpiece determined to be a defective product. The disclosure also provides a grinding machine operation command data adjustment model generating device that can acquire operation command data for the grinding machine using the grinding quality of the workpiece, the operation command data making it possible to improve the grinding quality. The disclosure also provides a grinding machine operation command data updating device that can update operation command data to improve grinding quality.

A first aspect of the disclosure relates to a grinding quality estimation model generating device. The grinding quality estimation model generating device includes a measured data acquiring unit configured to acquire measured data in a predetermined period for each of a plurality of workpieces, the measured data being data measured when grinding of the workpiece is performed using a grinding wheel in a grinding machine, and the measured data being at least one of first measured data indicating a state of a structural member of the grinding machine and second measured data associated with a grinding region; and a first learning model generating unit configured to generate a first learning model for estimating grinding quality of the workpiece by machine learning using the measured data associated with the plurality of workpieces as first learning input data.

The first learning model is generated by the machine learning using the measured data as the first learning input data. The measured data is at least one of the first measured data indicating the state of the structural member of the grinding machine and the second measured data associated with the grinding region. The measured data is data which is acquired in the predetermined period for each workpiece. For example, the measured data is data from a grinding start to a grinding end or data from a rough grinding start to a rough grinding end for each workpiece. Accordingly, the measured data on only one workpiece is a large amount of data. The measured data on a plurality of workpieces is an extremely large amount of data. However, the first learning model can be easily generated using the machine learning even when a large amount of the measured data on a plurality of workpieces is used.

Accordingly, by generating the first learning model in consideration of a large amount of the measured data that affects the grinding quality of the workpiece, it is possible to acquire grinding quality of the workpiece as a result. The first measured data indicating the state of the structural member of the grinding machine is, for example, vibration of the structural member or a deformation amount of the structural member. The second measured data associated with the grinding region is, for example, a size of the workpiece which varies due to grinding or a grinding point temperature.

In the grinding quality estimation model generating device according to the aspect, the measured data may be at least one of actual operation data on a driving device of the grinding machine, the first measured data, and the second measured data; the grinding quality estimation model generating device may further include a grinding characteristic calculating unit configured to calculate a value indicating a grinding characteristic based on the measured data in the predetermined period; and the first learning model generating unit may be configured to generate the first learning model for estimating the grinding quality of the workpiece by the machine learning using the measured data in the predetermined period and the value indicating the grinding characteristic as the first learning input data (first configuration).

In the grinding quality estimation model generating device according to the aspect, the measured data may be at least one of actual operation data on a driving device of the grinding machine, the first measured data, and the second measured data; and the grinding quality estimation model generating device may further include a grinding characteristic calculating unit configured to calculate a value indicating a grinding characteristic based on the measured data in the predetermined period, and a second learning model generating unit configured to generate a second learning model for estimating a surface state of the grinding wheel by the machine learning using the measured data in the predetermined period and the value indicating the grinding characteristic as the first learning input data (second configuration).

A grinding quality estimating device includes the grinding quality estimation model generating device according to the above-described aspect; and a grinding quality estimating unit configured to estimate grinding quality of a new workpiece using the first learning model and estimation input data which is the measured data in the predetermined period during grinding of the new workpiece. By using the first learning model which is generated by the machine learning, it is possible to estimate grinding quality of the new workpiece based on the estimation input data which is a large amount of the measured data on the new workpiece.

A poor quality factor estimating device includes the above-described grinding quality estimating device including a determination unit configured to determine whether the workpiece is non-defective or defective based on the grinding quality of the workpiece estimated by the grinding quality estimating unit; a non-defective product processing data storage unit configured to store non-defective product processing data which is prepared based on actual operation data associated with a non-defective product and acquired in advance, or the measured data associated with the non-defective product and acquired in advance, the actual operation data being data on a driving device controlled by a control device of the grinding machine; and a difference information extracting unit configured to compare the non-defective product processing data with defective product processing data which is the actual operation data or the measured data associated with the workpiece which has been determined to be a defective product by the determination unit, and to extract processing data difference information for identifying a poor quality factor that causes poor quality.

The poor quality factor estimating device can estimate the poor quality factor regarding the workpiece which has been determined to be defective by the determination unit, using the processing data difference information which is extracted by the difference information extracting unit.

A first grinding quality estimating device includes a first learning model storage unit configured to store the first learning model which is generated by the grinding quality estimation model generating device with the above-described first configuration; and a grinding quality estimating unit configured to estimate grinding quality of a new workpiece using the first learning model, and estimation input data which is the measured data in the predetermined period during grinding of the new workpiece.

A second grinding quality estimating device includes a second learning model storage unit configured to store the second learning model which is generated by the grinding quality estimation model generating device with the second configuration; and a surface state estimating unit configured to estimate the surface state of the grinding wheel when grinding of a new workpiece is performed, with use of the second learning model, and estimation input data which is the measured data in the predetermined period during grinding of the new workpiece.

A grinding machine operation command data updating device includes an operation command data acquiring unit configured to acquire, for each of a plurality of workpieces, operation command data for a control device of a grinding machine when the grinding of the workpiece is performed using a grinding wheel in the grinding machine; an incentive determining unit configured to determine, for each of the plurality of workpieces, an incentive for the operation command data based on grinding quality of the workpiece; a third learning model generating unit configured to generate a third learning model for adjusting the operation command data to increase the incentive by machine learning using the operation command data associated with the plurality of workpieces and the incentive; and an operation command data adjusting unit configured to adjust the operation command data using the operation command data associated with the grinding of a new workpiece, the grinding quality estimated by the first grinding quality estimating device, the incentive, and the third learning model.

A grinding machine operation command data updating device includes an operation command data acquiring unit configured to acquire, for each of a plurality of workpieces, operation command data for a control device of a grinding machine when the grinding of the workpiece is performed using a grinding wheel in the grinding machine; an incentive determining unit configured to determine, for each of the plurality of workpieces, an incentive for the operation command data based on a surface state of the grinding wheel; a third learning model generating unit configured to generate a third learning model for adjusting the operation command data to increase the incentive by machine learning using the operation command data associated with the plurality of workpieces and the incentive; and an operation command data adjusting unit configured to adjust the operation command data using the operation command data associated with the grinding of a new workpiece, the surface state estimated by the second grinding quality estimating device, the incentive, and the third learning model.

The first and second learning models are generated by the machine learning. The first learning input data in the machine learning includes the measured data in the predetermined period and the value indicating the grinding characteristic, which is calculated based on the measured data in the predetermined period. The measured data in the predetermined period is a data group (a group of a plurality of pieces of data) and may be affected by various factors. On the other hand, the value indicating the grinding characteristic may be data which is arranged based on the measured data. It is difficult to directly measure the value indicating grinding characteristic.

That is, the first and second learning models are generated using the measured data and the arranged value indicating the grinding characteristic. Thus, by using the arranged value indicating the grinding characteristic, it is possible to generate the first and second learning models in which a relationship with the grinding characteristic is emphasized. As a result, the estimated grinding quality or the estimated surface state of the grinding wheel is a result obtained by fully considering the grinding characteristic and is a result with higher accuracy. The grinding characteristic, which is difficult to directly measure, is acquired by calculation based on the measured data. By using the grinding characteristic, which is difficult to acquire only by measurement, as learning data, it is possible to acquire grinding quality with higher accuracy.

The grinding machine operation command data updating device performs processing using the estimated grinding quality or the estimated surface state of the grinding wheel as described above. That is, the grinding machine operation command data updating device can generate the third learning model for adjusting the operation command data and can update the operation command data, using the estimated grinding quality or the estimated surface state of the grinding wheel, which is a result obtained by fully considering the grinding characteristic. Accordingly, it is possible to appropriately update the operation command data based on the grinding quality of the workpiece or the surface state of the grinding wheel.

A second aspect of the disclosure relates to a grinding machine operation command data adjustment model generating device. The grinding machine operation command data adjustment model generating device includes an operation command data acquiring unit configured to acquire, for each of a plurality of workpieces, operation command data for a control device of a grinding machine when grinding of the workpiece is performed using a grinding wheel in the grinding machine; a grinding quality data acquiring unit configured to acquire, for each of the plurality of workpieces, grinding quality data on the workpiece; an incentive determining unit configured to determine, for each of the plurality of workpieces, an incentive for the operation command data based on the grinding quality data; and a third learning model generating unit configured to generate a third learning model for adjusting the operation command data to increase the incentive by machine learning using the operation command data associated with the plurality of the workpieces and the incentive.

The grinding machine operation command data adjustment model generating device generates the third learning model for adjusting the operation command data for the grinding machine by the machine learning. In the machine learning, the operation command data associated with the plurality of workpieces and the incentives are used. Accordingly, even when a large amount of data is used, it is possible to easily generate the third learning model by employing the machine learning. In the machine learning, the operation command data for the grinding machine is adjusted to increase the incentive which is determined using the grinding quality data on the workpiece. Accordingly, it is possible to generate the operation command data with which the grinding quality can be improved.

A grinding machine operation command data updating device includes the grinding machine operation command data adjustment model generating device according to the above-described aspect; and an operation command data adjusting unit configured to adjust the operation command data using the operation command data associated with grinding of a new workpiece, the grinding quality data on the new workpiece, the incentive, and the third learning model. That is, the operation command data is updated using the third learning model which is generated by the machine learning. Accordingly, even when a grinding state changes, the operation command data is updated based on the current grinding state. By updating the operation command data in this way, it is possible to improve the grinding quality of the workpiece.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a plan view illustrating a grinding machine;

FIG. 2 is a functional block diagram schematically illustrating a configuration of a machine learning device according to a first embodiment;

FIG. 3 is a functional block diagram illustrating a detailed configuration of a learning phase of the machine learning device according to the first embodiment;

FIG. 4 is a functional block diagram illustrating a detailed configuration of an estimation phase of the machine learning device according to the first embodiment;

FIG. 5 is a functional block diagram schematically illustrating a configuration of a machine learning device according to a second embodiment;

FIG. 6 is a functional block diagram illustrating a detailed configuration of a learning phase of the machine learning device according to the second embodiment;

FIG. 7 is a functional block diagram illustrating a detailed configuration of an estimation phase of the machine learning device according to the second embodiment;

FIG. 8 is a functional block diagram schematically illustrating a configuration of a machine learning device according to a third embodiment;

FIG. 9 is a functional block diagram illustrating a detailed configuration of a learning phase of the machine learning device according to the third embodiment;

FIG. 10 is a functional block diagram illustrating a detailed configuration of an estimation phase of the machine learning device according to the third embodiment;

FIG. 11 is a functional block diagram schematically illustrating a configuration of a machine learning device according to a fourth embodiment;

FIG. 12 is a functional block diagram illustrating a detailed configuration of a learning phase of the machine learning device according to the fourth embodiment;

FIG. 13 is a functional block diagram illustrating a detailed configuration of an estimation phase of the machine learning device according to the fourth embodiment;

FIG. 14 is a functional block diagram schematically illustrating a configuration of a machine learning device according to a fifth embodiment;

FIG. 15 is a functional block diagram illustrating a detailed configuration of first and second learning phases of the machine learning device according to the fifth embodiment; and

FIG. 16 is a functional block diagram illustrating a detailed configuration of an estimation phase and an update phase of the machine learning device according to the fifth embodiment.

### DETAILED DESCRIPTION OF EMBODIMENTS

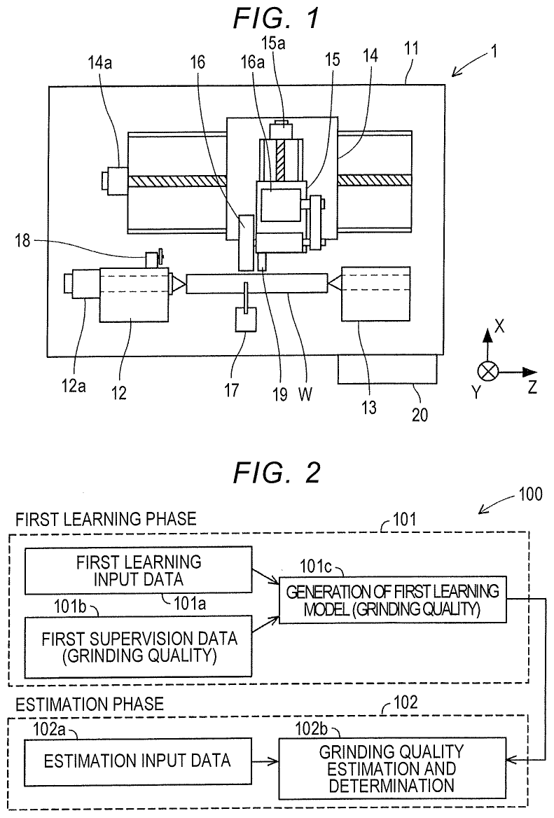

A first embodiment will be described below. The configuration of a grinding machine 1 will be described with reference to FIG. 1. The grinding machine 1 is a machine configured to grind a workpiece W. Grinding machines having various configurations such as a cylindrical grinding machine and a cam grinding machine can be applied as the grinding machine 1. In this embodiment, the grinding machine 1 is assumed to be a cylindrical grinding machine of wheel spindle stock traverse type. Here, the grinding machine 1 may be of a table traverse type.

The grinding machine 1 mainly includes a bed 11, a headstock 12, a tailstock 13, a traverse base 14, a wheel spindle stock 15, a grinding wheel 16, a sizing device 17, a grinding wheel truing device 18, a coolant device 19, and a control device 20. The headstock 12, the tailstock 13, the traverse base 14, and the wheel spindle stock 15 may be referred to as “structural members 12, 13, 14, and 15”.

The bed 11 is fixed onto an installation surface. The headstock 12 is provided on the top surface of the bed 11 at a position on a near side in an X-axis direction (the lower side in FIG. 1) and on one side in a Z-axis direction (the left side in FIG. 1). The headstock 12 supports a workpiece W such that the workpiece W is rotatable around the Z axis. The workpiece W is rotated by driving a motor 12a which is provided in the headstock 12. The tailstock 13 is provided on the top surface of the bed 11 at a position opposite to the headstock 12 in the Z-axis direction, that is, on the near side in the X-axis direction (the lower side in FIG. 1) and on the other side in the Z-axis direction (the right side in FIG. 1). That is, the headstock 12 and the tailstock 13 respectively support both ends of the workpiece W such that the workpiece W is rotatable.

The traverse base 14 is provided on the top surface of the bed 11 to be movable in the Z-axis direction. The traverse base 14 is moved by driving a motor 14a which is provided in the bed 11. The wheel spindle stock 15 is provided on the top surface of the traverse base 14 to be movable in the X-axis direction. The wheel spindle stock 15 is moved by driving a motor 15a which is provided in the traverse base 14. The grinding wheel 16 is rotatably supported by the wheel spindle stock 15. The grinding wheel 16 is rotated by driving a motor 16a which is provided in the wheel spindle stock 15. The grinding wheel 16 has a configuration in which a plurality of abrasive grains are fixed by a bonding material.

The sizing device 17 measures a size (a diameter) of a workpiece W. The grinding wheel truing device 18 corrects the shape of the grinding wheel 16. The grinding wheel truing device 18 is a device that performs truing of the grinding wheel 16. The grinding wheel truing device 18 may be a device that performs dressing of the grinding wheel 16 in addition to truing or instead of truing. The grinding wheel truing device 18 also has a function of measuring the size (the diameter) of the grinding wheel 16.

Here, truing is a shape correcting operation and includes an operation of shaping the grinding wheel 16 depending on the shape of the workpiece W when the grinding wheel 16 is worn by grinding, and an operation of removing unevenness of the grinding wheel 16 due to uneven wear. Dressing is a dressing (setting) operation and is an operation of adjusting a protruding amount of abrasive grains or creating cutting edges of abrasive grains. Dressing is an operation of correcting dulling, clogging, breaking (shedding of abrasive grains), and the like and is generally performed after truing. Truing and dressing may be performed without any particular distinction.

The coolant device 19 supplies a coolant to a grinding point at which the grinding wheel 16 grinds a workpiece W. The coolant device 19 cools a collected coolant to a predetermined temperature and supplies the coolant to the grinding point again.

The control device 20 controls driving devices based on a Numerical Control (NC) program which is generated based on operation command data such as the shape of a workpiece W, processing conditions (i.e., conditions for processing), the shape of the grinding wheel 16, and coolant supply timing information. That is, the control device 20 receives operation command data, generates an NC program based on the operation command data, and performs grinding of a workpiece W by controlling the motors 12a, 14a, 15a, and 16a, the coolant device 19, and the like based on the NC program. Particularly, the control device 20 performs grinding until the workpiece W has a finished shape, based on the diameter of the workpiece W which is measured by the sizing device 17. The control device 20 performs correction (truing and dressing) of the grinding wheel 16 by controlling the motors 12a, 14a, 15a, and 16a, the grinding wheel truing device 18, and the like at a time of correcting the grinding wheel 16.

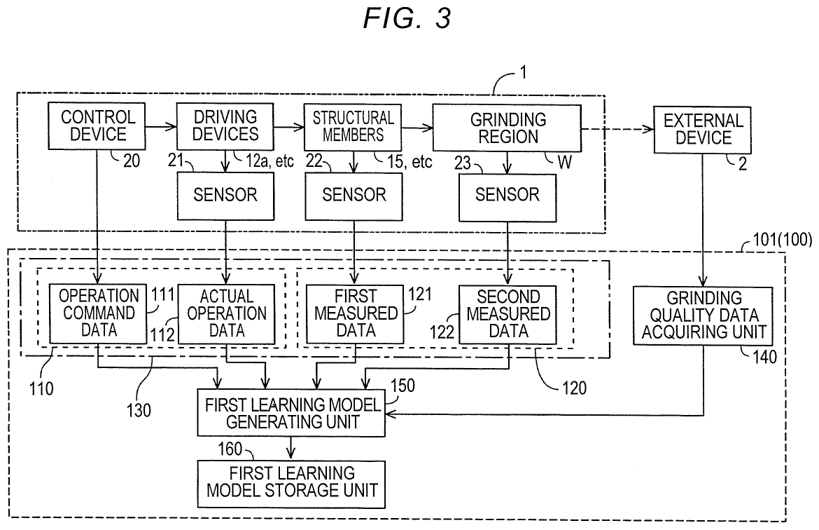

Although some are not illustrated in FIG. 1, the grinding machine 1 includes various sensors 21, 22, and 23 (which are illustrated in FIG. 3 or the like) which will be described later. For example, the grinding machine 1 includes sensors that detect actual operation data on the motors or the like and data indicating states of the structural members of the grinding machine 1, the sizing device 17, a grinding stone diameter sensor, and a temperature sensor. Details of the sensors and the like will be described later.

The configuration of a machine learning device 100 according to the first embodiment will be described below with reference to FIG. 2. The machine learning device 100 (a) generates a first learning model for estimating grinding quality of a workpiece W and (b) estimates grinding quality of the workpiece W using the first learning model. The machine learning device 100 may be configured as a device which is separate from the grinding machine 1 or may be configured as a device which is incorporated into the control device 20 or the like of the grinding machine 1. In this embodiment, the machine learning device 100 is connected to the grinding machine 1 via a network and transmits and receives various kinds of data thereto and therefrom.

The machine learning device 100 includes elements 101a, 101b, and 101c functioning in a first learning phase 101 that generates the first learning model and elements 102a and 102b that function in an estimation phase 102 (generally also referred to as an “inference phase”) that estimates grinding quality. The machine learning device 100 includes an element 101a that acquires first learning input data, an element 101b that acquires first supervision data, and an element 101c that generates a first learning model, as the elements functioning in the first learning phase 101.

First learning input data which is acquired by the element 101a is input data which is used for machine learning and examples thereof include operation command data, actual operation data, first measured data (data indicating the states of the structural members), and second measured data (data associated with a grinding region).

The first supervision data which is acquired by the element 101b is supervision data which is used for machine learning in supervised learning. The first supervision data is grinding quality data on a workpiece W and examples thereof include affected layer data on a workpiece W, surface quality data on a workpiece W, and chatter mark data on a workpiece W.

The first learning model which is generated by the element 101c is a model (a function) for estimating grinding quality of a workpiece W by performing supervised learning of the machine learning, based on the first learning input data and the first supervision data. Here, the first learning model may be generated by applying unsupervised learning for the purpose of classification of grinding quality. Here, when supervised learning is applied, it is possible to acquire grinding quality with high accuracy.

The machine learning device 100 includes an element 102a that acquires estimation input data and an element 102b that estimates grinding quality and determines whether a workpiece W is non-defective or defective, as the elements functioning in the estimation phase 102. The estimation input data which is acquired by the element 102a is the same kind of data as the first learning input data and is data which is acquired with regard to a workpiece W (a new workpiece W) other than the workpiece W which has been used for learning. The element 102b estimates grinding quality using the estimation input data and the first learning model and determines whether a workpiece W is non-defective or defective based on the estimated grinding quality. The first learning model which is used by the element 102b is the first learning model which is generated by the machine learning in the first learning phase 101.

The configuration of the grinding machine 1 associated with the machine learning device 100 will be described below with reference to FIG. 3. As illustrated in FIG. 3, the grinding machine 1 includes the control device 20. The control device 20 is a so-called computerized numerical control (CNC) device. As described above, the control device 20 generates an NC program based on the operation command data and controls various driving devices 12a, 14a, 15a, 16a, 17, and 18 (described as “12a, etc.” in FIG. 3) based on the NC program.

By driving the driving devices 12a, 14a, 15a, 16a, 17, and 18, the structural members 12, 13, 14, and 15 (described as “15, etc.” in FIG. 3) are operated. When the structural members 12, 13, 14, and 15 operate, grinding of a workpiece W is performed using the grinding wheel 16. In FIG. 3, a region of the workpiece W which is ground by the grinding wheel 16 is described as a grinding region.

The grinding machine 1 further includes a sensor 21 that detects actual operation data on the driving devices 12a, etc., a sensor 22 that detects states of the structural members 15, etc. (data indicating states of the structural members), and a sensor 23 that detects data associated with a grinding region W (grinding region data) which varies according to grinding. Examples of the sensor 21 include a current sensor that detects a drive current of the motor 12a and a position sensor that detects a current position (a rotational angle) of the motor 12a. The sensor 21 detects the same information for other driving devices 14a, 15a, 16a, 17, and 18. Examples of the sensor 22 include a vibration sensor that detects vibration of the structural members 15, etc. and a strain sensor that detects deformation of the structural members 15, etc. A sensor that detects acceleration corresponding to vibration or a sensor that detects sound waves corresponding to vibration can be employed as the vibration sensor. Examples of the sensor 23 include the sizing device that detects a size (a diameter) of a workpiece W which varies according to grinding and a temperature sensor that detects a grinding point temperature at the time of grinding.

The configuration of an external device 2 associated with the machine learning device 100 will be described below with reference to FIG. 3. The external device 2 detects grinding quality data on a workpiece W which has been ground by the grinding wheel 16 in the grinding machine 1, for each workpiece W. The grinding quality data includes, for example, affected layer data (data on, for example, a grinding burn mark), surface quality data (data on, for example, surface roughness), and chatter mark data.

That is, the external device 2 includes an affected layer detector that acquires affected layer data (data on a grinding burn mark and a softened layer due to grinding), a surface quality measurer that acquires surface quality data (data on, for example, surface roughness), and a chatter detector that acquires chatter mark data. The external device 2 may be a device that directly acquires the data. The external device 2 may be a device that acquires other data having a correlation with target data and acquires the target data by performing calculation using the other data, that is, a device that indirectly acquires target data.

The affected layer data may be data on whether there is an affected layer or may be a score associated with a degree of affection of an affected layer. The surface quality data may be a value of surface roughness or may be a score associated with a degree of surface roughness. The chatter mark data may be data on whether there is chatter marks or may be a score associated with a degree of chattering of chatter marks. The scores are expressed, for example, with the use of a plurality of grades.

The detailed configuration of the first learning phase 101 of the machine learning device 100 will be described below with reference to FIG. 3. The configuration of the first learning phase 101 corresponds to a grinding quality estimation model generating device.

The configuration of the first learning phase 101 includes a first input data acquiring unit 130 that acquires first input data, a grinding quality data acquiring unit 140 that acquires grinding quality data, a first learning model generating unit 150, and a first learning model storage unit 160.

The first input data acquiring unit 130 acquires first input data on a plurality of workpieces W as the first learning input data of machine learning. The grinding quality data acquiring unit 140 acquires grinding quality data on the plurality of workpieces W as first supervision data of machine learning. Here, the first learning input data and the first supervision data are described in Table 1. As described in Table 1, although the first learning input data includes a plurality of pieces of data, not all pieces of data described in Table 1 need to be used and only some data may be used.

TABLE 1

| | Data | | |
|---|---|---|---|
| | classification | Sensor, | |
| | name | measurer | Data name |
| First | Operation | | Command cutting |
| learning | command | | speed |
| input data | data | | Command position |
| | | | Command rotation |
| | | | speed of grinding |
| | | | wheel |
| | | | Command rotation |
| | | | speed of workpiece |
| | | | Coolant supply |
| | | | information |
| | Actual | Current | Drive current of motor |
| | operation | sensor | |
| | data | Position | Actual position of |
| | | sensor | motor |
| | First measured | Vibration | Vibration of structural |
| | data (structural | sensor | member |
| | member | Strain sensor | Deformation of |
| | state data) | | structural member |
| | Second measured | Sizing device | Size of workpiece |
| | data | Temperature | Grinding point |
| | (grinding region | sensor | temperature |
| | data) | | |
| First | Grinding quality | Affected layer | Affected layer data |
| supervision | data | detector | |
| data | | Surface quality | Surface quality data |
| | | measurer | |
| | | Chatter mark | Chatter mark data |
| | | detector | |

The first input data acquiring unit 130 includes an operation-relevant data acquiring unit 110 and a measured data acquiring unit 120. The operation-relevant data acquiring unit 110 includes an operation command data acquiring unit 111 that acquires operation command data for the control device 20 and an actual operation data acquiring unit 112 that acquires actual operation data on the driving devices 12a, etc. which are controlled by the control device 20, from the sensor 21.

Operation command data of the operation-relevant data includes a command cutting speed for each process, command positions of moving objects 14 and 15 at the time of switching between the processes, a command rotation speed of the grinding wheel 16, a command rotation speed of a workpiece W, and coolant supply information as described in Table 1. Here, grinding of a workpiece W is performed, for example, through a plurality of grinding processes such as rough grinding, accurate grinding, fine grinding, and spark-out. Actual operation data of the operation-relevant data includes drive currents of the motors 12a, etc. and actual positions of the motors 12a, etc. as described in Table 1. The actual operation data acquiring unit 112 acquires actual operation data in a predetermined period for each workpiece W. The predetermined period is, for example, a period from a grinding start to a grinding end or a period from a rough grinding start to a rough grinding end. Since grinding is unstable in a non-steady state, data may be acquired in only a steady state.

The measured data acquiring unit 120 includes a first measured data acquiring unit 121 that acquires first measured data from the sensor 22 and a second measured data acquiring unit 122 that acquires second measured data from the sensor 23. The first measured data is data measured when grinding of a workpiece W is performed using the grinding wheel 16, and examples of the first measured data include vibration of the structural members 15, etc. and deformation (i.e., deformation amounts) of the structural members 15, etc. The second measured data is data measured when grinding of a workpiece W is performed using the grinding wheel 16, and examples of the second measured data include a size (a diameter) of a workpiece W and a grinding point temperature.

The first measured data acquiring unit 121 acquires the first measured data in the predetermined period for each workpiece W. The second measured data acquiring unit 122 also acquires the second measured data in the predetermined period for each workpiece W. The first measured data and the second measured data are acquired in the same predetermined period as the period in which the actual operation data is acquired. The predetermined period is, for example, a period from a grinding start to a grinding end or a period from a rough grinding start to a rough grinding end.

The grinding quality data acquiring unit 140 acquires grinding quality data on a plurality of workpieces W acquired by the external device 2 as first supervision data of supervised learning. That is, the grinding quality data acquiring unit 140 acquires, for example, affected layer data (data on a grinding burn mark and a softened layer due to grinding), surface quality data (data on, for example, surface roughness), and chatter mark data as first supervision data.

The first learning model generating unit 150 performs supervised learning and generates a first learning model. Specifically, the first learning model generating unit 150 generates the first learning model for estimating grinding quality of a workpiece W by machine learning using the first input data associated with a plurality of workpieces W acquired by the first input data acquiring unit 130, as first learning input data, and using grinding quality data on the plurality of workpieces W acquired by the grinding quality data acquiring unit 140, as first supervision data.

That is, the first learning model generating unit 150 generates the first learning model by machine learning using the operation command data, the actual operation data, the first measured data, and the second measured data as the first learning input data and using the grinding quality data as the first supervision data. The first learning model is a model indicating a relationship between the first learning input data and the first supervision data.

Here, at least the actual operation data, the first measured data, and the second measured data of the first learning input data are data in the predetermined period for each workpiece W. Accordingly, the first learning input data on only one workpiece W is a large amount of data. First learning input data on a plurality of workpieces W is an extremely large amount of data. However, the first learning model can be easily generated using the machine learning even when a large amount of first learning input data on a plurality of workpieces W is used. Accordingly, by generating the first learning model in consideration of a large amount of first learning input data that affects the grinding quality of a workpiece W, it is possible to acquire grinding quality of a workpiece W, which will be described later.

The first learning model is a model for estimating an affected layer state of a workpiece W, surface quality of the workpiece W, and a chatter mark state of the workpiece W as the grinding quality of the workpiece W. The first learning model is not limited to a case in which all kinds of the grinding quality are estimated, and only one or some kinds of the grinding quality may be estimated. The first learning model which is generated by the first learning model generating unit 150 is stored in the first learning model storage unit 160.

When the predetermined period in which data is acquired is a period from a grinding start to a grinding end, the first learning model is a model in which all grinding processes are considered. On the other hand, when the predetermined period is, for example, a period from a rough grinding start to a rough grinding end, the first learning model is a learning model in which only a rough grinding process is considered. When it is required to specify processes that affect the grinding quality, the first learning model may be acquired for each process.

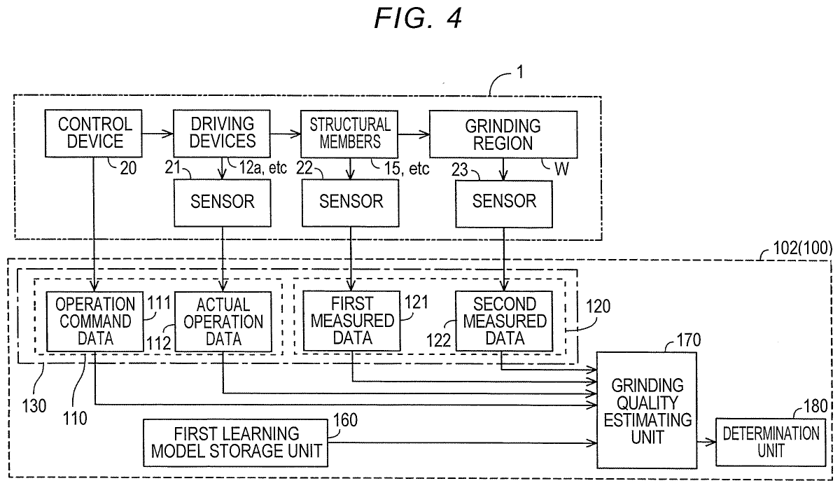

The detailed configuration of the estimation phase 102 of the machine learning device 100 will be described below with reference to FIG. 4. Here, the configuration of the first learning phase 101 and the configuration of the estimation phase 102 correspond to a grinding quality estimating device. The configuration of the first learning phase 101 is as described above.

The configuration of the estimation phase 102 includes a first input data acquiring unit 130 that acquires first input data, a first learning model storage unit 160, a grinding quality estimating unit 170, and a determination unit 180. The first input data acquiring unit 130 acquires first input data in a predetermined period during grinding of a new workpiece W. The first input data acquiring unit 130 is substantially the same as the first input data acquiring unit 130 described in the first learning phase 101. Here, it is assumed that the predetermined period is the same as the predetermined period in the first learning phase 101. The first learning model storage unit 160 stores the first learning model which is generated by the first learning model generating unit 150 as described in the first learning phase 101.

The grinding quality estimating unit 170 estimates grinding quality of a new workpiece W by using the first input data in the predetermined period during grinding of the new workpiece W as estimation input data, and using the first learning model stored in the first learning model storage unit 160. Here, the first learning model is a model indicating a relationship between the first learning input data and the first supervision data as described above. The first learning model is a model relating to an affected layer state of the workpiece W, surface quality of the workpiece W, and a chatter mark state of the workpiece W as grinding quality data which is the first supervision data.

Therefore, the grinding quality estimating unit 170 estimates an affected layer state of the workpiece W, surface quality of the workpiece W, and a chatter mark state of the workpiece W as the grinding quality. The grinding quality estimating unit 170 may estimate only one or some kinds of grinding quality instead of estimating all kinds of grinding quality. For example, the grinding quality estimating unit 170 may estimate only the affected layer state. In this case, the first learning model is generated as a model for estimating only the affected layer state.

The grinding quality estimating unit 170 estimates a plurality of objects as described above. By using the first learning model which is generated by machine learning, the grinding quality estimating unit 170 can easily estimate a plurality of objects. In this way, the machine learning device 100 can estimate complicated objects at a time.

The determination unit 180 determines whether a workpiece W is non-defective or defective based on the grinding quality of the workpiece W which is estimated by the grinding quality estimating unit 170. For example, when it is determined based on the estimated affected layer state that there is an affected layer in a workpiece W (a predetermined condition has not been satisfied), the determination unit 180 determines that the workpiece W is defective. When it is determined that the estimated surface quality has not satisfied a predetermined condition, the determination unit 180 determines that the workpiece W is defective. When it is determined based on the estimated chatter mark state that there is a chatter mark (a predetermined condition has not been satisfied), the determination unit 180 determines that the workpiece W is defective.

On the other hand, when the affected layer state, the surface quality, and the chatter mark state of a workpiece W satisfy the corresponding conditions, the determination unit 180 determines that the workpiece W is non-defective. In this way, by using the first learning model which is generated by machine learning, it is possible to easily perform determination regarding a plurality of conditions.

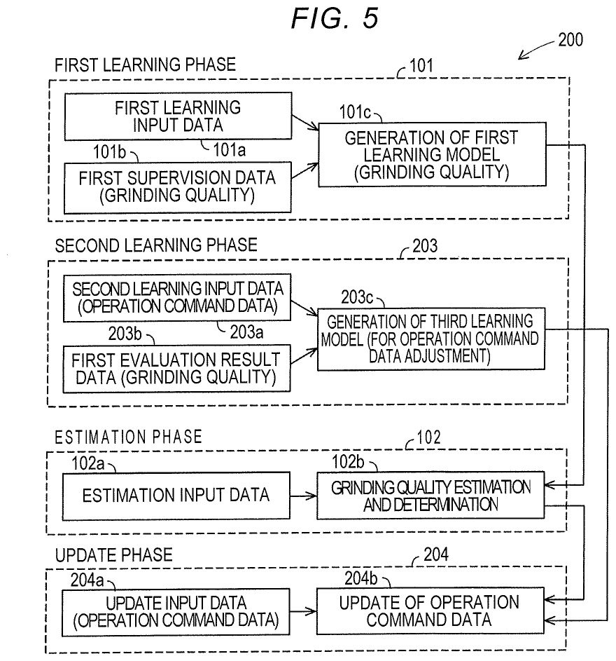

The configuration of a machine learning device 200 according to a second embodiment will be described below with reference to FIG. 5. Similarly to the machine learning device 100 according to the first embodiment, the machine learning device 200 (a) generates a first learning model for estimating grinding quality of a workpiece W and (b) estimates grinding quality of the workpiece W using the first learning model. The machine learning device 200 (c) generates a third learning model for adjusting operation command data for the grinding machine 1 to improve grinding quality and (d) updates the operation command data for the grinding machine 1 to improve the grinding quality using the third learning model.

The machine learning device 200 includes elements 101a, 101b, and 101c that function in a first learning phase 101 that generates a first learning model, and elements 102a and 102b that function in an estimation phase 102 that estimates grinding quality. The first learning phase 101 and the estimation phase 102 have the same configurations as the corresponding phases in the first embodiment.

The machine learning device 200 includes an element 203a that acquires second learning input data, an element 203b that acquires first evaluation result data, and an element 203c that generates a third learning model, as elements that function in a second learning phase 203 that generates the third learning model.

The second learning input data which is acquired by the element 203a is input data which is used for machine learning, and an example of the second learning input data is operation command data. The operation command data includes a command cutting speed for each process, command positions of moving objects 14 and 15 at the time of switching the processes, a command rotation speed of the grinding wheel 16, a command rotation speed of a workpiece W, and coolant supply information as described in Table 1 in the first embodiment. The operation command data is data for generating an NC program which is executed in the control device 20.

The first evaluation result data which is acquired by the element 203b is evaluation result data for deriving an incentive which is used for machine learning in reinforcement learning. The first evaluation result data is grinding quality data on a workpiece W, and examples of the first evaluation result data include affected layer data on a workpiece W, surface quality data on the workpiece W, and chatter mark data on the workpiece W. The third learning model which is generated by the element 203c is a model (a function) for adjusting the operation command data for the grinding machine 1 by performing reinforcement learning of the machine learning based on the second learning input data and the first evaluation result data.

The machine learning device 200 includes an element 204a that acquires update input data and an element 204b that updates the operation command data, as elements functioning in an update phase 204 that updates the operation command data. The update input data which is acquired by the element 204a is the same kind of data as the second learning input data and is data which is acquired with regard to a workpiece W (a new workpiece W) other than the workpiece W which has been used for learning. The element 204b updates the operation command data using the update input data, the third learning model, and the estimated grinding quality. The third learning model which is used by the element 204b is the third learning model which is generated by machine learning in the second learning phase 203. The estimated grinding quality is the grinding quality which is estimated by the estimation phase 102.

The detailed configuration of the first learning phase 101 of the machine learning device 200 is the same as in the first embodiment.

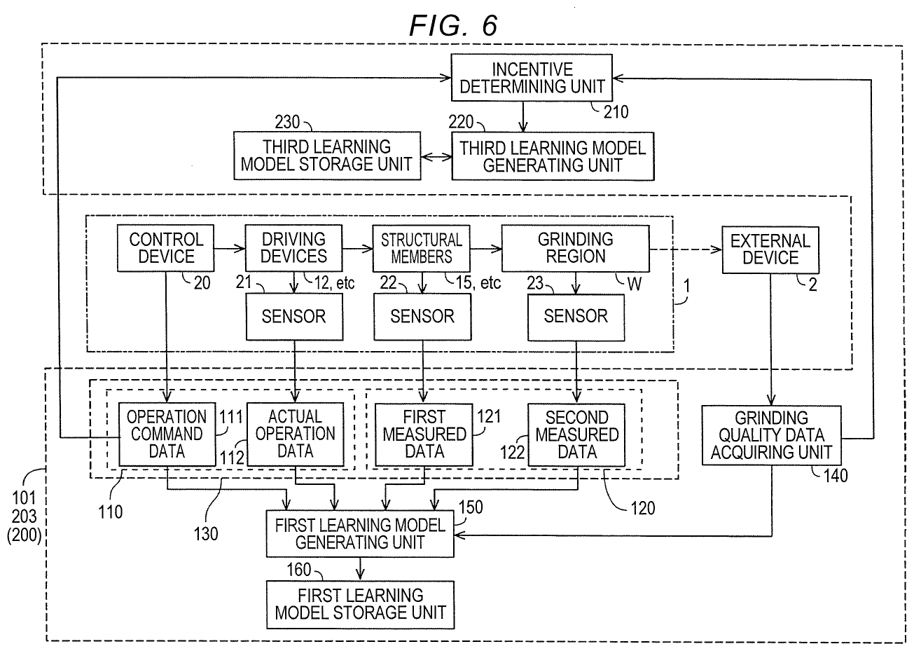

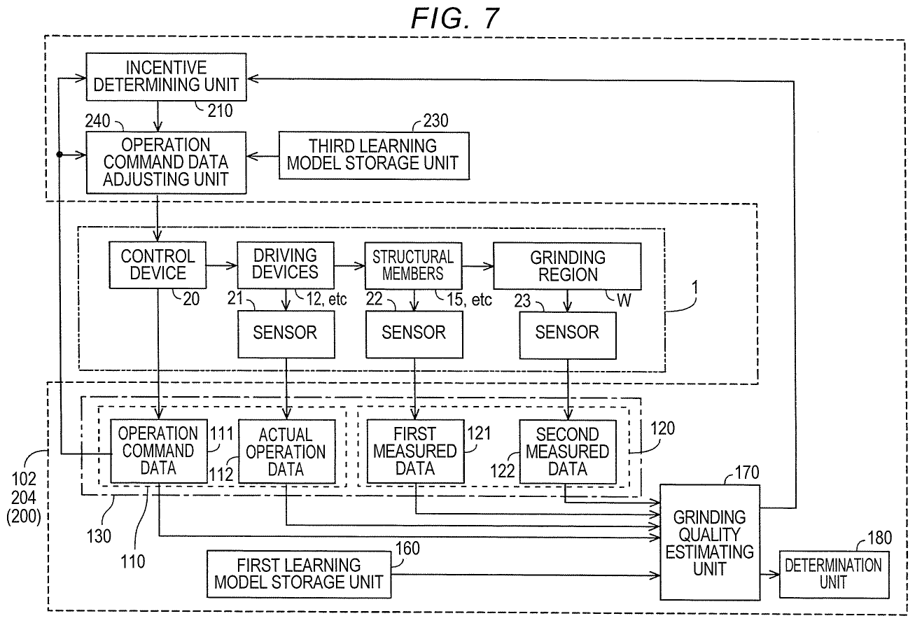

The detailed configuration of the second learning phase 203 of the machine learning device 200 will be described below with reference to FIG. 6. Here, the configuration of the second learning phase 203 corresponds to a grinding machine operation command data adjustment model generating device.

The configuration of the second learning phase 203 includes an operation command data acquiring unit 111, a grinding quality data acquiring unit 140, an incentive determining unit 210, a third learning model generating unit 220, and a third learning model storage unit 230.

The operation command data acquiring unit 111 acquires operation command data for the control device 20 of the grinding machine 1 when grinding of a workpiece W is performed using the grinding wheel 16 of the grinding machine 1. The operation command data acquiring unit 111 acquires operation command data on a plurality of workpieces W, as the second learning input data of machine learning. The grinding quality data acquiring unit 140 acquires grinding quality data on the plurality of workpieces W, as the first evaluation result data of machine learning. Here, the second learning input data and the first evaluation result data are described in Table 2. Here, as described in Table 2, the second learning input data includes a plurality of pieces of data, but not all pieces of data described in Table 2 need to be used and only some data may be used.

TABLE 2

| | Data | | |
|---|---|---|---|
| | classification | Sensor, | |
| | name | measurer | Data name |
| Second | Operation | | Command cutting |
| learning | command | | speed |
| input data | data | | Command position |
| | | | Command rotation |
| | | | speed of grinding |
| | | | wheel |
| | | | Command rotation |
| | | | speed of workpiece |
| | | | Coolant supply |
| | | | information |
| First | Grinding quality | Affected layer | Affected layer data |
| evaluation | data | detector | |
| result data | | Surface quality | Surface quality data |
| | | measurer | |
| | | Chatter mark | Chatter mark data |
| | | detector | |

The incentive determining unit 210 acquires the operation command data which is the second learning input data, and the grinding quality data which is the first evaluation result data, and determines an incentive for the operation command data based on the grinding quality data. Here, the incentive is an incentive for a combination of operation command data in reinforcement learning. A high incentive is given to operation command data when the grinding quality data corresponding to the operation command data causes a desirable result, and a low incentive (including a minus incentive) is given to operation command data when the grinding quality data corresponding to the operation command data causes an undesirable result.

For example, the incentive determining unit 210 increases the incentive when there is no affected layer in the affected layer data on a workpiece W and decreases the incentive when there is an affected layer. The incentive determining unit 210 increases the incentive when the surface quality data on a workpiece W is equal to or less than a predetermined threshold value and decreases the incentive when the surface quality data is greater than the predetermined threshold value. The incentive determining unit 210 increases the incentive when there is no chatter mark in the chatter mark data on a workpiece W and decreases the incentive when there is a chatter mark. The incentive determining unit 210 may determine the incentive based on all of the affected layer data, the surface quality data, and the chatter mark data or may determine the incentive based on only one or some thereof.

The third learning model generating unit 220 generates a third learning model for adjusting operation command data to increase an incentive by machine learning. In the third learning model generating unit 220, for example, Q learning, Sarsa, or a Monte Carlo method is applied as the reinforcement learning.

Here, it is assumed that the operation command data before being adjusted is data on a first workpiece W and the operation command data after being adjusted is data on a second workpiece W. A relationship between the operation command data on the first workpiece W and the grinding quality data on the first workpiece W is referred to as a first data relationship. A relationship between the operation command data on the second workpiece W and the grinding quality data on the second workpiece W is referred to as a second data relationship.

The third learning model is a model indicating a correlation between the first data relationship before adjustment and the second data relationship after adjustment. The third learning model generating unit 220 learns a method of adjustment from the unadjusted operation command data on the first workpiece W (i.e., the operation command data on the first workpiece W before adjustment) to the adjusted operation command data on the second workpiece W (i.e., the operation command data on the second workpiece W after adjustment) such that the grinding quality data on the second workpiece W after adjustment is better than the grinding quality data on the first workpiece W before adjustment, that is, such that the incentive increases.

The adjusted operation command data is obtained by adjusting the unadjusted operation command data within a preset range of limitation. For example, regarding the command cutting speed which is one adjustable parameter, the command cutting speed after being adjusted is limited to a range based on a predetermined rate (for example, ±3%) with respect to the command cutting speed before being adjusted. The predetermined rate can be set to any rate. The same applies to other adjustable parameters. Other adjustable parameters can be set. The generated third learning model is stored in the third learning model storage unit 230.

The third learning model generating unit 220 can also learn the third learning model in the update phase 204 which will be described later. In this case, the grinding quality data which is acquired by the estimation phase 102 (which has been described in the first embodiment) is used as the grinding quality data which is the first evaluation result data.

The estimation phase 102 of the machine learning device 200 is the same as the estimation phase 102 in the first embodiment.

The detailed configuration of the update phase 204 of the machine learning device 200 will be described below with reference to FIG. 7. Here, the configuration of the second learning phase 203 and the update phase 204 corresponds to a grinding machine operation command data updating device. The configuration of the second learning phase 203 is as described above.

The configuration of the update phase 204 includes an operation command data acquiring unit 111, a grinding quality data acquiring unit 140, an incentive determining unit 210, a third learning model storage unit 230, and an operation command data adjusting unit 240.

The operation command data acquiring unit 111 and the grinding quality data acquiring unit 140 acquire data on grinding of a new workpiece W and are substantially the same as the operation command data acquiring unit 111 and the grinding quality data acquiring unit 140 described in the second learning phase 203. The incentive determining unit 210 determines an incentive using the operation command data and the grinding quality data which are acquired during grinding of a new workpiece W. That is, the incentive determining unit 210 determines an incentive for the operation command data based on the grinding quality data, with regard to grinding of a new workpiece W. The third learning model storage unit 230 stores the third learning model which is generated by the third learning model generating unit 220 as described in the second learning phase 203.

The operation command data adjusting unit 240 determines a method of adjusting operation command data using the operation command data with regard to grinding of a new workpiece W, the grinding quality data on the new workpiece W, the incentive, and the third learning model, and adjusts the operation command data based on the determined adjustment method. Here, the third learning model is a model which is generated by learning the method of adjustment from the operation command data before being adjusted to the operation command data after being adjusted to increase the incentive.

Specifically, the operation command data adjusting unit 240 acquires current operation command data as the operation command data before being adjusted and acquires the incentive therefor. In this case, the operation command data adjusting unit 240 determines target operation command data to which the current operation command data is adjusted, with the use of the current operation command data, the incentive for the current operation command data, and the third learning model. That is, the target operation command data is operation command data for which the incentive higher than the incentive for the current operation command data is provided.

In the process performed by the operation command data adjusting unit 240, a plurality of candidates of the target operation command data with the same incentive may be output. In this case, the operation command data adjusting unit 240 can rank the plurality of candidates, for example, by setting priorities for parameters to be adjusted. For example, when the priorities are set for the parameters to be adjusted, the first priority may be given to the command cutting speed and the second priority may be given to the command rotation speed of a workpiece W.

Then, the operation command data adjusting unit 240 determines that the candidate at the first rank should be the target operation command data, and updates the current operation command data to the target operation command data. Then, the grinding machine 1 performs grinding of a workpiece W based on the updated operation command data. In the update phase 204 of the machine learning device 200, the operation command data in next grinding is adjusted again based on data on grinding of the workpiece W. A frequency of adjustment of the operation command data may be set. For example, the operation command data may be adjusted after grinding of a preset number of workpieces W is performed.

That is, the operation command data is updated using the third learning model which is generated by machine learning of the machine learning device 200. Accordingly, even when a grinding state changes, the operation command data is updated based on a current grinding state. By updating the operation command data in this way, it is possible to improve grinding quality of a workpiece W.

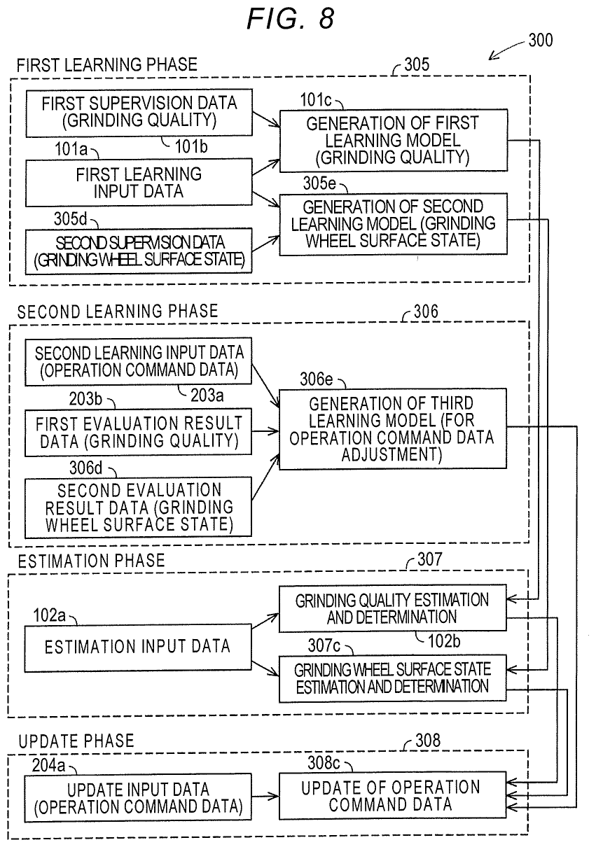

The configuration of a machine learning device 300 according to a third embodiment will be described below with reference to FIG. 8. The machine learning device 300 (a) generates a first learning model for estimating grinding quality of a workpiece W and (b) estimates grinding quality of the workpiece W using the first learning model. The machine learning device 300 (e) generates a second learning model for estimating a surface state of the grinding wheel 16 and (f) estimates the surface state of the grinding wheel 16 using the second learning model. The machine learning device 300 (g) generates a third learning model for adjusting operation command data for the grinding machine 1 to improve grinding quality and to decrease a frequency of correction or replacement of the grinding wheel 16 and (h) updates the operation command data for the grinding machine 1 to improve the grinding quality and to decrease the frequency of correction or replacement of the grinding wheel 16 using the third learning model.

The machine learning device 300 includes elements 101a, 101b, 101c, 305d, and 305e that function in a first learning phase 305 that generates the first learning model and the second learning model. The machine learning device 300 includes an element 101a that acquires first learning input data, an element 101b that acquires first supervision data, an element 101c that generates a first learning model, an element 305d that acquires second supervision data, and an element 305e that generates the second learning model as elements that function in the first learning phase 305. The elements 101a, 101b, and 101c have the same configurations as those of the corresponding elements in the first embodiment.

The second supervision data which is acquired by the element 305d is supervision data which is used for machine learning of supervised learning. The second supervision data is data indicating the surface state of the grinding wheel 16 (surface state data on the grinding wheel 16). Examples of the surface state data on the grinding wheel 16 include data on a state in which dulling, clogging, breaking (shedding of abrasive grains), or the like occurs and data on a state in which excessive dressing has been performed.

The surface of the grinding wheel 16 affects the grinding quality of a workpiece W. That is, the surface state of the grinding wheel 16 indicates an extent to which the grinding quality of a workpiece W is affected. The surface state of the grinding wheel 16 includes, for example, the state in which dulling, clogging, breaking (shedding of abrasive grains), or the like occurs and a state in which excessive dressing has been performed. When the surface state of the grinding wheel 16 is not good, the grinding quality of a workpiece W may decrease. Accordingly, it is necessary to determine the surface state of the grinding wheel 16.

When the surface state of the grinding wheel 16 is a state in which dulling, clogging, breaking (shedding of abrasive grains), or the like occurs, it is necessary to perform dressing or to perform dressing after shaping by truing. When the surface state of the grinding wheel 16 is a state in which excessive dressing has been performed, it is necessary to perform truing. In general, dressing is performed after truing is performed. When the number of times of truing reaches a predetermined number or when a predetermined amount of shaping is performed by truing, it is necessary to replace the grinding wheel 16.

In order to extend a lifespan of the grinding wheel 16, it is necessary to decrease the number of times of truing and dressing. When truing, dressing, and replacement of the grinding wheel 16 are performed, a grinding cycle time extends due to the times required therefor. It is required to shorten the grinding cycle time. From this point of view, it is necessary to determine the surface state of the grinding wheel 16. Therefore, the element 305d acquires surface state data on the grinding wheel 16 as second supervision data. The surface state data on the grinding wheel 16 is data indicating an extent to which grinding quality of a workpiece is affected.

The second learning model which is generated by the element 305e is a model (a function) for estimating the surface state of the grinding wheel 16 by performing supervised learning of the machine learning based on the first learning input data and the second supervision data. Here, the second learning model may be generated by applying unsupervised learning for the purpose of classification of the surface state of the grinding wheel 16. Here, when supervised learning is applied, it is possible to acquire the surface state of the grinding wheel 16 with high accuracy.

The machine learning device 300 includes elements 203a, 203b, 306d, and 306e functioning in a second learning phase 306 that generates a third learning model. The machine learning device 300 includes an element 203a that acquires second learning input data, an element 203b that acquires first evaluation result data, an element 306d that acquires second evaluation result data, and an element 306e that generates the third learning model, as the elements functioning in the second learning phase 306. The elements 203a and 203b have the same configurations as those of the corresponding elements in the second embodiment.

The second evaluation result data which is acquired by the element 306d is evaluation result data for deriving an incentive which is used for machine learning in reinforcement learning. The second evaluation result data is surface state data on the grinding wheel 16. The third learning model which is generated by the element 306e is a model (a function) for adjusting operation command data for the grinding machine 1 by performing reinforcement learning of the machine learning based on the second learning input data, the first evaluation result data, and the second evaluation result data.

The machine learning device 300 includes an element 102a that acquires estimation input data and an element 102b that estimates grinding quality and determines whether a workpiece W is non-defective or defective, as the elements functioning in an estimation phase 307 that estimates the grinding quality and the surface state of the grinding wheel 16. Here, the elements 102a and 102b have the same configurations as those of the corresponding elements in the first embodiment.

The machine learning device 300 includes an element 307c that estimates the surface state of the grinding wheel 16 and determines whether truing of the grinding wheel 16 is to be executed, whether dressing of the grinding wheel 16 is to be executed, and whether replacement of the grinding wheel 16 is to be executed, as an element functioning in the estimation phase 307. The element 307c estimates the surface state of the grinding wheel 16 using the estimation input data and the second learning model, and determines whether truing of the grinding wheel 16 is to be executed, whether dressing of the grinding wheel 16 is to be executed, and whether replacement of the grinding wheel 16 is to be executed based on the estimated surface state of the grinding wheel 16. The second learning model which is used by the element 307c is the second learning model which is generated by machine learning in the first learning phase 305.

The machine learning device 300 includes an element 204a that acquires update input data and an element 308c that updates operation command data, as elements functioning in an update phase 308 that updates the operation command data. Here, the element 204a has the same configuration as that of the corresponding element in the second embodiment. The element 308c updates the operation command data using the update input data, the third learning model, the estimated grinding quality, and the estimated surface state of the grinding wheel 16. The third learning model which is used by the element 308c is the third learning model which is generated by machine learning in the second learning phase 306. The estimated grinding quality is the grinding quality which is estimated in the estimation phase 307. The estimated surface state of the grinding wheel 16 is the surface state of the grinding wheel 16 which is estimated in the estimation phase 307.

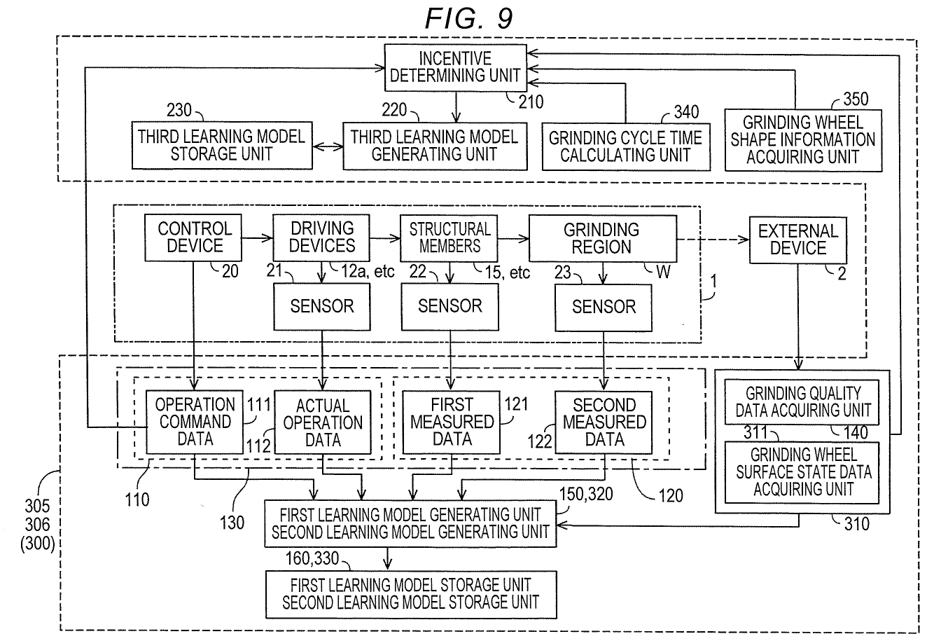

The detailed configuration of the first learning phase 305 of the machine learning device 300 will be described below with reference to FIG. 9. The configuration of the first learning phase 305 is included in a grinding quality estimation model generating device and a grinding wheel surface state estimation model generating device. The configuration of the first learning phase 305 includes a first input data acquiring unit 130, a quality data acquiring unit 310, a first learning model generating unit 150, a second learning model generating unit 320, a first learning model storage unit 160, and a second learning model storage unit 330.

The first input data acquiring unit 130 acquires first input data on a plurality of workpieces W as first learning input data for machine learning. The quality data acquiring unit 310 includes a grinding quality data acquiring unit 140 that acquires grinding quality data, and a grinding wheel surface state data acquiring unit 311 that acquires surface state data on the grinding wheel 16. The grinding quality data acquiring unit 140 acquires grinding quality data on a plurality of workpieces W as first supervision data for machine learning. The grinding wheel surface state data acquiring unit 311 acquires the surface state of the grinding wheel 16 after grinding is performed on each workpiece W, as second supervision data for machine learning. Here, the first learning input data, the first supervision data, and the second supervision data are described in Table

TABLE 3

| | Data | | |
|---|---|---|---|
| | classification | Sensor, | |
| | name | measurer | Data name |
| First | Operation | | Command cutting |
| learning | command | | speed |
| input data | data | | Command position |
| | | | Command rotation |
| | | | speed of grinding |
| | | | wheel |
| | | | Command rotation |
| | | | speed of workpiece |
| | | | Coolant supply |
| | | | information |
| | Actual | Current | Drive current of motor |
| | operation | sensor | |
| | data | Position | Actual position of |
| | | sensor | motor |
| | First measured | Vibration | Vibration of structural |
| | data (structural | sensor | member |
| | member | Strain sensor | Deformation of |
| | state data) | | structural member |
| | Second measured | Sizing device | Size of workpiece |
| | data | Temperature | Grinding point |
| | (grinding region | sensor | temperature |
| | data) | | |
| First | Grinding quality | Affected layer | Affected layer data |
| supervision | data | detector | |
| data | | Surface quality | Surface quality data |
| | | measurer | |
| | | Chatter mark | Chatter mark data |
| | | detector | |
| Second | Grinding wheel | Affected layer | First surface state data |
| supervision | surface state data | detector | (corresponding to |
| data | | | affected layer) |
| | | Surface quality | Second surface state |
| | | measurer | data (corresponding to |
| | | | surface quality) |
| | | Chatter mark | Third surface state |
| | | detector | data (corresponding |
| | | | to chatter mark) |

The first input data acquiring unit 130 and the grinding quality data acquiring unit 140 have the same configurations as the corresponding configurations in the first embodiment. The grinding wheel surface state data acquiring unit 311 acquires surface state data on the grinding wheel 16 corresponding to the grinding quality data on a workpiece W which is acquired by the external device 2, as second supervision data for supervised learning.

The surface state data on the grinding wheel 16 includes first surface state data corresponding to a state of an affected layer of a workpiece W, second surface state data corresponding to surface quality of the workpiece W, and third surface state data corresponding to a state of a chatter mark of the workpiece W. The first surface state data may be affected layer data itself or may be data which is calculated based on the affected layer data. The second surface state data may be surface quality data of the workpiece W itself or may be data which is calculated based on the surface quality data. The third surface state data may be chatter mark data itself or may be data which is calculated based on the chatter mark data.

The first learning model generating unit 150 generates the first learning model and has the same configuration as the corresponding configuration in the first embodiment. The first learning model storage unit 160 stores the first learning model which is generated by the first learning model generating unit 150.

The second learning model generating unit 320 generates the second learning model by performing supervised learning. Specifically, the second learning model generating unit 320 generates the second learning model for estimating the surface state of the grinding wheel 16 by machine learning using the first input data acquired by the first input data acquiring unit 130 as the first learning input data, and using the surface state data on the grinding wheel 16 for each workpiece W acquired by the grinding wheel surface state data acquiring unit 311 as the second supervision data.

That is, the second learning model generating unit 320 generates the second learning model by machine learning using the operation command data, the actual operation data, the first measured data, and the second measured data as the first learning input data, and using the grinding wheel surface state data as the second supervision data. The second learning model is a model indicating a relationship between the first learning input data and the second supervision data. Even when there are a plurality of kinds of first learning input data, the second learning model can be generated by applying machine learning.

The second learning model is a model for estimating an extent to which grinding quality of a workpiece is affected as the surface state of the grinding wheel 16. For example, the first learning model is a model for estimating a state in which dulling, clogging, breaking (shedding of abrasive grains), or the like occurs in the grinding wheeling 16, a state in which excessive dressing has been performed on the grinding wheel 16, or the like, as the surface state of the grinding wheel 16.

For example, the first learning model is a model for estimating first surface state data corresponding to a state of an affected layer of a workpiece W, second surface state data corresponding to surface quality of the workpiece W, and third surface state data corresponding to a state of a chatter mark of the workpiece W, as the surface state of the grinding wheel 16. Here, the second learning model is not limited to a case in which all the surface states are estimated, and one or some surface states may be estimated. The second learning model which is generated by the second learning model generating unit 320 is stored in the second learning model storage unit 330.

The detailed configuration of the second learning phase 306 of the machine learning device 300 will be described below with reference to FIG. 9. The configuration of the second learning phase 306 is included in a grinding wheel operation command data adjustment model generating device.

The configuration of the second learning phase 306 includes an operation command data acquiring unit 111, a grinding quality data acquiring unit 140, a grinding wheel surface state data acquiring unit 311, a grinding cycle time calculating unit 340, a grinding wheel shape information acquiring unit 350, an incentive determining unit 210, a third learning model generating unit 220, and a third learning model storage unit 230.

The operation command data acquiring unit 111 acquires operation command data on a plurality of workpieces W as the second learning input data for machine learning. The grinding quality data acquiring unit 140 acquires grinding quality data on the plurality of workpieces W as the first evaluation result data for machine learning. The grinding wheel surface state data acquiring unit 311 acquires surface state data on the grinding wheel 16 after grinding is performed on each workpiece W, as the second evaluation result data for machine learning. Here, the second learning input data, the first evaluation result data, and the second evaluation result data are described in Table 4. Here, as described in Table 4, the second learning input data includes a plurality of pieces of data, but not all pieces of data described in Table 4 need to be used and only some data may be used.

TABLE 4

| | Data | | |
|---|---|---|---|
| | classification | Sensor, | |
| | name | measurer | Data name |
| Second | Operation | | Command cutting |
| learning | command | | speed |
| input data | data | | Command position |
| | | | Command rotation |
| | | | speed of grinding |
| | | | wheel |
| | | | Command rotation |
| | | | speed of workpiece |
| | | | Coolant supply |
| | | | information |
| First | Grinding quality | Affected layer | Affected layer data |
| evaluation | data | detector | |
| result data | | Surface quality | Surface quality data |
| | | measurer | |
| | | Chatter mark | Chatter mark data |
| | | detector | |
| Second | Grinding wheel | Affected layer | First surface state data |
| evaluation | surface state data | detector | (corresponding to |
| result data | | | affected layer) |
| | | Surface quality | Second surface state |
| | | measurer | data (corresponding to |
| | | | surface quality) |
| | | Chatter mark | Third surface state |
| | | detector | data (corresponding |
| | | | to chatter mark) |

The grinding cycle time calculating unit 340 calculates a grinding cycle time for one workpiece W. The grinding cycle time is a value obtained by dividing the sum of the time required for grinding a plurality of workpieces W, the time required for replacement of the grinding wheel 16 in the grinding, the time required for dressing of the grinding wheel 16 in the grinding, and the time required for truing of the grinding wheel 16 in the grinding by the number of workpieces W. That is, as the number of times of replacement of the grinding wheel 16 decreases, as the number of times of dressing of the grinding wheel 16 decreases, and as the number of times of truing of the grinding wheel 16 decreases, the grinding cycle time decreases.

The grinding wheel shape information acquiring unit 350 acquires shape information on the grinding wheel 16. The grinding wheel shape information acquiring unit 350 acquires a size (a diameter) of the grinding wheel 16 which is measured by the grinding wheel truing device 18. That is, the grinding wheel shape information acquiring unit 350 acquires the shape information on the grinding wheel 16 when truing or dressing of the grinding wheel 16 is performed by the grinding wheel truing device 18. The grinding wheel shape information acquiring unit 350 may acquire size change of the grinding wheel 16 and deformation of the grinding wheel 16 as the shape information on the grinding wheel 16.

The incentive determining unit 210 acquires the operation command data which is the second learning input data, the grinding quality data which is the first evaluation result data, and the surface state data on the grinding wheel 16 which is the second evaluation result data, and determines an incentive for the operation command data based on the grinding quality data and the surface state data. Here, the incentive is an incentive for a combination of operation command data in reinforcement learning.

Similarly to the second embodiment, a high incentive is given to operation command data when the grinding quality data corresponding to the operation command data causes a desirable result, and a low incentive (including a minus incentive) is given to operation command data when the grinding quality data corresponding to the operation command data causes an undesirable result.

A high incentive is given to operation command data when the surface state data corresponding to the operation command data causes a desirable result, and a low incentive is given to operation command data when the surface state data corresponding to the operation command data causes an undesirable result.

For example, the incentive determining unit 210 increases the incentive when there is no affected layer corresponding to the first surface state data, and decreases the incentive when there is an affected layer. The incentive determining unit 210 increases the incentive when the surface quality data on a workpiece W corresponding to the second surface state data is equal to or less than a predetermined threshold value and decreases the incentive when the surface quality data is greater than the predetermined threshold value. The incentive determining unit 210 increases the incentive when there is no chatter mark corresponding to the third surface state data, and decreases the incentive when there is a chatter mark.

The incentive determining unit 210 acquires the grinding cycle time which is calculated by the grinding cycle time calculating unit 340, and determines the incentive for the operation command data based on the grinding cycle time. Specifically, the incentive determining unit 210 increases the incentive as the grinding cycle time decreases. That is, the incentive determining unit 210 increases the incentive as at least one of the time required for replacement of the grinding wheel 16, the time required for dressing of the grinding wheel 16, and the time required for truing of the grinding wheel 16 decreases.

The incentive determining unit 210 determines the incentive based on the shape information on the grinding wheel 16 which is acquired by the grinding wheel shape information acquiring unit 350. Specifically, the incentive determining unit 210 increases the incentive as the size change of the grinding wheel 16 decreases and as the deformation of the grinding wheel 16 decreases.

The third learning model generating unit 220 generates the third learning model for adjusting the operation command data to increase the incentive by machine learning. The generated third learning model is stored in the third learning model storage unit 230.

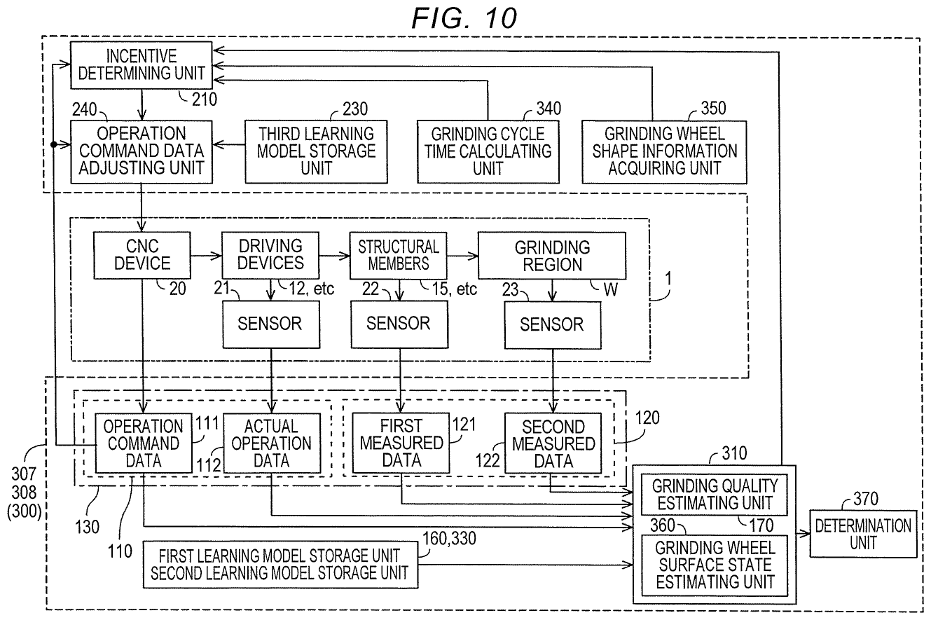

The detailed configuration of the estimation phase 307 of the machine learning device 300 will be described below with reference to FIG. 10. The configuration of the estimation phase 307 includes a first input data acquiring unit 130, a first learning model storage unit 160, a second learning model storage unit 330, a grinding quality estimating unit 170, a grinding wheel surface state estimating unit 360, and a determination unit 370.

The grinding wheel surface state estimating unit 360 estimates the surface state of the grinding wheel 16 when grinding of a new workpiece W is performed, using the first input data in a predetermined period during grinding of the new workpiece W as estimation input data, and using the second learning model stored in the second learning model storage unit 330. Here, the second learning model is a model indicating a relationship between the first learning input data and the second supervision data as described above.

Therefore, the grinding wheel surface state estimating unit 360 estimates an extent to which grinding quality of a workpiece W is affected as the surface state of the grinding wheel 16. For example, the grinding wheel surface state estimating unit 360 estimates a first surface state corresponding to an affected layer state of the workpiece W, a second surface state corresponding to surface quality of the workpiece W, and a third surface state corresponding to a chatter mark state of the workpiece W, as the surface state of the grinding wheel 16. Here, the grinding wheel surface state estimating unit 360 may estimate only one or some of the surface states instead of estimating all the surface states of the grinding wheel 16. For example, the grinding wheel surface state estimating unit 360 may estimate only the first surface state. In this case, the first learning model is generated as a model for estimating only the first surface state.

The grinding wheel surface state estimating unit 360 estimates a plurality of objects as the surface state as described above. The grinding wheel surface state estimating unit 360 can easily estimate a plurality of objects using the second learning model which is generated by machine learning. In this way, the machine learning device 300 can estimate complicated objects at a time.

The determination unit 370 determines whether a workpiece W is non-defective or defective based on the grinding quality of the workpiece W which is estimated by the grinding quality estimating unit 170. The determination unit 370 determines at least one of i) whether truing of the grinding wheel 16 is to be executed, ii) whether dressing of the grinding wheel 16 is to be executed, and iii) whether replacement of the grinding wheel 16 is to be executed, based on the surface state of the grinding wheel 16 estimated by the grinding wheel surface state estimating unit 360.

The detailed configuration of the update phase 308 of the machine learning device 300 will be described below with reference to FIG. 10. The configuration of the update phase 308 includes an operation command data acquiring unit 111, a grinding quality data acquiring unit 140, a grinding wheel surface state data acquiring unit 311, a grinding cycle time calculating unit 340, a grinding wheel shape information acquiring unit 350, an incentive determining unit 210, a third learning model storage unit 230, and an operation command data adjusting unit 240.

The operation command data acquiring unit 111, the grinding quality data acquiring unit 140, and the grinding wheel surface state data acquiring unit 311 acquire data on grinding of a new workpiece W, and are substantially the same as those described in the second learning phase 306. The grinding cycle time calculating unit 340 and the grinding wheel shape information acquiring unit 350 are also substantially the same as those described in the second learning phase 306.

The incentive determining unit 210 determines an incentive using the operation command data, the grinding quality data, and the surface state data on the grinding wheel 16 which are acquired during grinding the new workpiece W. That is, the incentive determining unit 210 determines an incentive for the operation command data based on the grinding quality data and the surface state data on the grinding wheel 16 with regard to grinding of the new workpiece W. The incentive determining unit 210 determines an incentive for the operation command data based on the grinding cycle time and the shape information on the grinding wheel 16. The third learning model storage unit 230 stores the third learning model which is generated by the third learning model generating unit 220 as described in the second learning phase 306.

The operation command data adjusting unit 240 determines a method of adjusting operation command data using the operation command data for grinding of a new workpiece W, the grinding quality data on the new workpiece W, the surface state data on the grinding wheel 16 when grinding of the new workpiece W is performed, the incentive, and the third learning model, and adjusts the operation command data based on the determined adjustment method. Here, the third learning model is a model which is generated by learning the method of adjustment from the operation command data before being adjusted to the operation command data after being adjusted to increase the incentive. The operation command data adjusting unit 240 is substantially the same as the operation command data adjusting unit 240 described in the second embodiment.

The operation command data is updated using the third learning model which is generated by machine learning of the machine learning device 300. Accordingly, even when the grinding state changes, the operation command data is updated based on the current grinding state. By updating the operation command data in this way, it is possible to improve the grinding quality of a workpiece W.

By updating the operation command data, it is possible to perform grinding based on the surface state of the grinding wheel. That is, by updating the operation command data, the surface state of the grinding wheel 16 is improved. When the surface state of the grinding wheel 16 is improved, it is possible to improve the grinding quality of a workpiece W. By updating the operation command data, the time required for replacement of the grinding wheel 16, the time required for dressing of the grinding wheel 16, and the time required for truing of the grinding wheel 16 decrease. As a result, the grinding cycle time is shortened. By updating the operation command data, it is possible to decrease size change of the grinding wheel 16 and to decrease deformation of the grinding wheel 16.

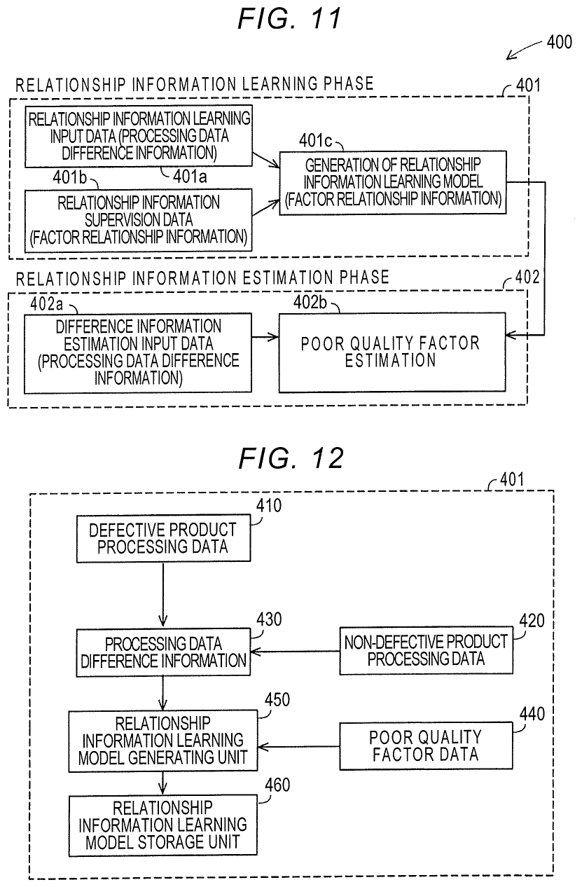

The configuration of a machine learning device 400 according to a fourth embodiment will be described below with reference to FIG. 11. The machine learning device 400 (a) generates a relationship information learning model for estimating a poor quality factor (i.e., a factor that causes poor quality) of a workpiece W which has been determined to be defective and (b) estimates a poor quality factor regarding the workpiece W which has been determined to be defective, using the relationship information learning model. The configuration of the machine learning device 400 is included in a poor quality factor estimating device.

The machine learning device 400 includes an element 401a that acquires relationship information learning input data, an element 401b that acquires relationship information supervision data, and an element 401c that generates a relationship information learning model, as the elements functioning in a relationship information learning phase 401 that generates a relationship information learning model.

The relationship information learning input data which is acquired by the element 401a is input data which is used for machine learning, and examples of the relationship information learning input data include actual operation data, first measured data, and second measured data. The relationship information supervision data which is acquired by the element 401b is supervision data which is used for machine learning in supervised learning. The relationship information supervision data is information on a poor quality factor regarding a workpiece W, and examples of the relationship information supervision data include information on conditions (such as a feed speed) for processing performed on a workpiece W by the grinding machine 1, and information on sharpness of the grinding wheel 16. The relationship information learning model which is generated by the element 401c is a model (a function) for estimating grinding quality of a workpiece W by performing supervised learning of the machine learning based on the relationship information learning input data and the relationship information supervision data.

The machine learning device 400 includes an element 402a that acquires estimation input data and an element 402b that estimates a poor quality factor (i.e., a factor that causes poor quality) as elements functioning in an estimation phase 402 that estimates the poor quality factor. The estimation input data which is acquired by the element 402a is the same kind of data as the relationship information learning input data and is data which is acquired with regard to a workpiece W (a new workpiece W) other than the workpiece W which has been used for learning. The element 402b estimates a poor quality factor using the estimation input data and the relationship information learning model. The relationship information learning model which is used by the element 402b is the relationship information learning model which is generated by machine learning in the relationship information learning phase 401.

The detailed configuration of the relationship information learning phase 401 of the machine learning device 400 will be described below with reference to FIG. 12. The configuration of the relationship information learning phase 401 includes a defective product processing data storage unit 410, a non-defective product processing data storage unit 420, a difference information extracting unit 430, a poor quality factor data storage unit 440, a relationship information learning model generating unit 450, and a relationship information learning model storage unit 460.

The defective product processing data storage unit 410 acquires and stores a plurality of kinds of processing data (defective product processing data) on a plurality of workpieces W which are defective products, as relationship information learning input data for machine learning in advance. The defective product processing data includes information on poor quality of a workpiece W which is a defective product. The poor quality includes grinding quality which can be estimated by the grinding quality estimating unit 170 and a surface state of the grinding wheel 16 which can be estimated by the grinding wheel surface state estimating unit 360.

The non-defective product processing data storage unit 420 acquires and stores a plurality of kinds of processing data (non-defective product processing data) on a plurality of workpieces W which are non-defective products, as relationship information supervision data for machine learning in advance. The kinds of the non-defective product processing data correspond to the kinds of the defective product processing data. Examples of the kinds of the defective product processing data and the non-defective product processing data include actual operation data which is acquired from the sensor 21 by the actual operation data acquiring unit 112 and first measured data and second measured data which are acquired from the sensors 22 and 23 by the measured data acquiring unit 120.

In this embodiment, a plurality of kinds of non-defective product processing data are stored in the non-defective product processing data storage unit 420, but at least one kind of non-defective product processing data may be stored in the non-defective product processing data storage unit 420.

The difference information extracting unit 430 acquires defective product processing data and non-defective product processing data, and compares the non-defective product processing data and the defective product processing data with each other. The difference information extracting unit 430 extracts processing data indicting difference between the defective product processing data and the non-defective product processing data, as processing data difference information. The poor quality factor data storage unit 440 acquires and stores information on a poor quality factor (poor quality factor data) of the workpiece W in advance. A condition (a feed speed) for processing performed on a workpiece W by the grinding machine 1, sharpness of the grinding wheel 16, a processing point temperature, and vibration of a constituent component of the grinding machine 1 are exemplified as the poor quality factor data stored in the poor quality factor data storage unit 440.

The relationship information learning model generating unit 450 performs supervised learning and generates a relationship information learning model. Specifically, the relationship information learning model generating unit 450 generates a relationship information learning model for estimating a factor (a poor quality factor) that causes poor quality of a workpiece W by machine learning using the processing data difference information extracted by the difference information extracting unit 430 as relationship information learning input data and using the poor quality factor data stored in the poor quality factor data storage unit 440 as relationship information supervision data.

The relationship information learning model storage unit 460 stores the relationship information learning model which is generated by the relationship information learning model generating unit 450. In the relationship information learning model storage unit 460, a relationship learning model is stored in correlation with a plurality of kinds of poor quality of a workpiece W which has been determined to be defective (the grinding quality estimated by the grinding quality estimating unit 170, the surface state of the grinding wheel 16 estimated by the grinding wheel surface state estimating unit 360, or the like). Correlation of the relationship learning model with the poor quality in the relationship information learning model storage unit 460 may be omitted.

In this way, the relationship information learning model generating unit 450 generates a learning model associated with factor relationship information (a relationship information learning model) indicating a relationship between the processing data difference information and the poor quality factor. The relationship information learning model is a model for estimating a factor that causes poor quality of a workpiece W which has been determined to be defective. The machine learning device 400 can clarify the relationship between the processing data difference information and the poor quality factor by using the relationship information learning model.

In this embodiment, the relationship information learning model storage unit 460 stores a plurality of kinds of relationship information learning models indicating relationships between the processing data difference information and a plurality of kinds of poor quality factors, but may store only one or some of the plurality of kinds of relationship information learning models.

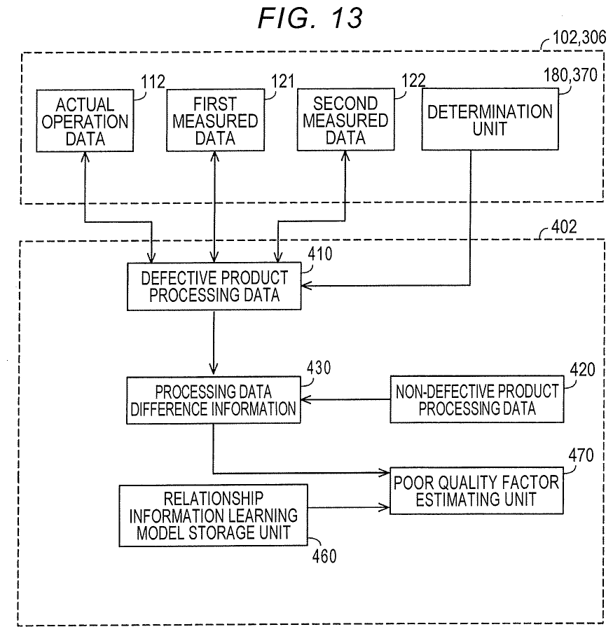

The detailed configuration of the estimation phase 402 of the machine learning device 400 will be described below with reference to FIG. 13. The configuration of the estimation phase 402 includes a defective product processing data storage unit 410, a non-defective product processing data storage unit 420, a difference information extracting unit 430, a relationship information learning model storage unit 460, and a poor quality factor estimating unit 470.

When the determination unit 180 or 370 determines that a workpiece W which has been newly ground is defective, the defective product processing data storage unit 410 acquires and stores the actual operation data, the first measured data, and the second measured data from the actual operation data acquiring unit 112, the first measured data acquiring unit 121, and the second measured data acquiring unit 122.

The difference information extracting unit 430 extracts a difference between the defective product processing data and the non-defective product processing data as new processing data difference information by comparing the defective product processing data which is newly acquired and stored by the defective product processing data storage unit 410 with the non-defective product processing data stored in the non-defective product processing data storage unit 420.

Then, the poor quality factor estimating unit 470 estimates a poor quality factor that causes poor quality of the newly ground workpiece W using the newly extracted processing data difference information as estimation input data and using the relationship information learning model stored in the relationship information learning model storage unit 460. Accordingly, the machine learning device 400 can estimate a poor quality factor that causes poor quality of the workpiece W which has been determined to be defective by the determination unit 180 or 370. The poor quality factor estimating unit 470 estimates a poor quality factor based on the processing data difference information extracted by the difference information extracting unit 430. Accordingly, the poor quality factor estimating unit 470 can easily estimate the poor quality factor.

In this embodiment, a plurality of kinds of non-defective product processing data are stored in the non-defective product processing data storage unit 420, and the difference information extracting unit 430 compares the defective product processing data with the plurality of kinds of non-defective product processing data and extracts a plurality of kinds of processing data difference information. Accordingly, since the poor quality factor estimating unit 470 can select one poor quality factor among a plurality of kinds of poor quality factors, it is possible to enhance accuracy of estimation performed by the poor quality factor estimating unit 470.

The non-defective product processing data stored in the non-defective product processing data storage unit 420 is prepared based on actual operation data or measured data on a plurality of non-defective products, the actual operation data or the measured data being acquired in advance. Thus, it is possible to enhance quality of the non-defective product processing data. Accordingly, the difference information extracting unit 430 can accurately extract the processing data difference information.

In this embodiment, the machine learning device 400 estimates a poor quality factor using a learning model associated with the factor relationship information, but the factor relationship information is not limited to the learning model which is generated by machine learning. That is, the machine learning device 400 may store, as the factor relationship information, information in which one piece of processing data difference information acquired by comparing the defective product processing data acquired from at least one workpiece W which is a defective product with the non-defective product processing data acquired from at least one workpiece W which is a non-defective product is correlated with information on specific poor quality of the workpiece W which is a defective product. In this case, the poor quality factor estimating unit 470 can estimate whether the workpiece W has specific poor quality based on the processing data difference information based on the defective product processing data acquired from a workpiece W which is newly determined to be defective and the non-defective product processing data, and the factor relationship information.

In the update phases 204 and 308 in the second embodiment and the third embodiment, the operation command data adjusting unit 240 may adjust the operation command data based on the result of estimation performed by the poor quality factor estimating unit 470. In this case, the machine learning devices 200 and 300 can improve grinding quality of a workpiece.

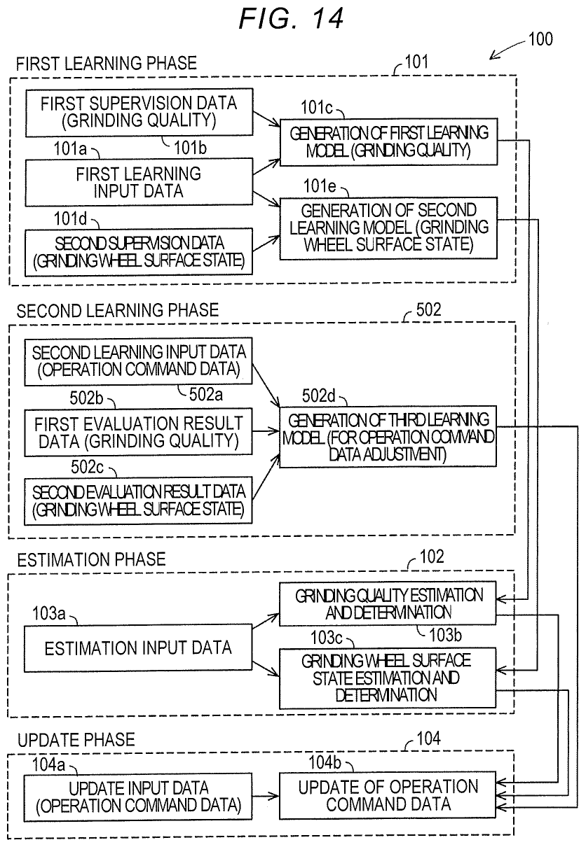

The configuration of a machine learning device 100 according to a fifth embodiment will be described below with reference to FIG. 14. The machine learning device 100 performs following processes (a) to (f): (a) generating a first learning model for estimating grinding quality of a workpiece W; (b) estimating grinding quality of the workpiece W using the first learning model; (c) generating a second learning model for estimating a surface state of the grinding wheel 16; (d) estimating the surface state of the grinding wheel 16 using the second learning model; (e) generating a third learning model for adjusting operation command data for the grinding machine 1 to improve grinding quality and to decrease a frequency of correction or replacement of the grinding wheel 16; and (f) updating the operation command data for the grinding machine 1 to improve the grinding quality and to decrease the frequency of correction or replacement of the grinding wheel 16, using the third learning model.

The machine learning device 100 may be configured as a device which is separate from the grinding machine 1 or may be configured as a device which is incorporated into the control device 20 or the like of the grinding machine 1. In this embodiment, the machine learning device 100 is connected to the grinding machine 1 via a network and transmits and receives various kinds of data thereto and therefrom.

A first learning phase 101 corresponding to processes (a) and (c) will be described below. As illustrated in FIG. 14, the machine learning device 100 includes elements 101a, 101b, 101c, 101d, and 101e functioning in the first learning phase 101 that generates a first learning model and a second learning model. The machine learning device 100 includes an element 101a that acquires first learning input data, an element 101b that acquires first supervision data, an element 101c that generates a first learning model, and an element 101d that acquires second supervision data, and an element 101e that generates a second learning model, as the elements functioning in the first learning phase 101.

The first learning input data which is acquired by the element 101a is input data which is used for machine learning, and examples of the first learning input data include operation command data for the control device 20 of the grinding machine 1, a plurality of kinds of sampling data (measured data) in a predetermined period for each workpiece W, and a value indicating grinding characteristics, which is calculated from the plurality of kinds of sampling data. The sampling data (measured data) includes, for example, actual operation data, first measured data (data indicating the states of the structural members), and second measured data (data associated with a grinding region).

The first supervision data which is acquired by the element 101b is supervision data which is used for machine learning in supervised learning. The first supervision data is grinding quality data on a workpiece W and examples of the first supervision data include affected layer data on the workpiece W, surface quality data on the workpiece W, and chatter mark data on the workpiece W.

The first learning model which is generated by the element 101c is a model (a function) for estimating grinding quality of a workpiece W by performing supervised learning of the machine learning based on the first learning input data and the first supervision data. Here, the first learning model may be generated by applying unsupervised learning for the purpose of classification of grinding quality. Here, when supervised learning is applied, it is possible to acquire grinding quality with high accuracy.

The second supervision data which is acquired by the element 101d is supervision data which is used for machine learning in supervised learning. The second supervision data is data indicating a surface state of the grinding wheel 16 (surface state data on the grinding wheel 16). The surface state data on the grinding wheel 16 includes, for example, data on a state in which dulling, clogging, breaking (shedding of abrasive grains), or the like occurs and data on a state in which excessive dressing has been performed.

The surface of the grinding wheel 16 affects the grinding quality of a workpiece W. That is, the surface state of the grinding wheel 16 indicates an extent to which the grinding quality of a workpiece W is affected. The surface state of the grinding wheel 16 includes, for example, a state in which dulling, clogging, breaking (shedding of abrasive grains), or the like occurs and a state in which excessive dressing has been performed. When the surface state of the grinding wheel 16 is not good, the grinding quality of a workpiece W may decrease. Accordingly, it is necessary to determine the surface state of the grinding wheel 16.

When the surface state of the grinding wheel 16 is a state in which dulling, clogging, breaking (shedding of abrasive grains), or the like occurs, it is necessary to perform dressing or to perform dressing after shaping by truing. When the surface state of the grinding wheel 16 is a state in which excessive dressing has been performed, it is necessary to perform truing. In general, dressing is performed after truing is performed. When the number of times of truing reaches a predetermined number or when a predetermined amount of shaping is performed by truing, it is necessary to replace the grinding wheel 16.

In order to extend a lifespan of the grinding wheel 16, it is necessary to decrease the number of times of truing and dressing. When truing, dressing, and replacement of the grinding wheel 16 are performed, a grinding cycle time extends due to the times required therefor. It is required to shorten the grinding cycle time. From this point of view, it is necessary to determine the surface state of the grinding wheel 16. Therefore, the element 101d acquires surface state data on the grinding wheel 16 as second supervision data. The surface state data on the grinding wheel 16 is data indicating an extent to which grinding quality of a workpiece is affected.

The second learning model which is generated by the element 101e is a model (a function) for estimating the surface state of the grinding wheel 16 by performing supervised learning of the machine learning based on the first learning input data and the second supervision data. Here, the second learning model may be generated by applying unsupervised learning for the purpose of classification of the surface state of the grinding wheel 16. Here, when supervised learning is applied, it is possible to acquire the surface state of the grinding wheel 16 with high accuracy.

A second learning phase 502 corresponding to process (e) will be described below. As illustrated in FIG. 14, the machine learning device 100 includes elements 502a, 502b, 502c, and 502d functioning in the second learning phase 502 that generates a third learning model. The machine learning device 100 includes an element 502a that acquires second learning input data, an element 502b that acquires first evaluation result data, an element 502c that acquires second evaluation result data, and an element 502d that generates a third learning model, as the elements functioning in the second learning phase 502.

The second learning input data which is acquired by the element 502a is input data which is used for machine learning, and examples of the second learning input data include operation command data. The first evaluation result data which is acquired by the element 502b is evaluation result data for deriving an incentive which is used for machine learning in reinforcement learning. The first evaluation result data is grinding quality data on a workpiece W, and examples of the first evaluation result data include affected layer data on the workpiece W, surface quality data on the workpiece W, and chatter mark data on the workpiece W.

The second evaluation result data which is acquired by the element 502c is evaluation result data for deriving an incentive which is used for machine learning in reinforcement learning. The second evaluation result data is surface state data on the grinding wheel 16. The third learning model which is generated by the element 502d is a model (a function) for adjusting operation command data for the grinding machine 1 by performing reinforcement learning of the machine learning based on the second learning input data, the first evaluation result data, and the second evaluation result data.

An estimation phase 102 corresponding to processes (b) and (d) will be described below. As illustrated in FIG. 14, the machine learning device 100 includes an element 103a that acquires estimation input data and an element 103b that estimates grinding quality and determines whether a workpiece W is non-defective or defective, as elements functioning in the estimation phase 102. The machine learning device 100 includes an element 103c that estimates a surface state of the grinding wheel 16 and determines whether truing of the grinding wheel 16 is to be executed, whether dressing of the grinding wheel 16 is to be executed, and whether replacement of the grinding wheel 16 is to be executed, as an element functioning in the estimation phase 102.

The estimation input data which is acquired by the element 103a is the same kind of data as the first learning input data and is data which is acquired with regard to a workpiece W (a new workpiece W) other than the workpiece W which has been used for learning. That is, the estimation input data includes a plurality of kinds of sampling data and a value indicating grinding characteristics. The element 103b estimates grinding quality using the estimation input data and the first learning model, and determines whether a workpiece W is non-defective or defective based on the estimated grinding quality. The first learning model which is used by the element 103b is the first learning model which is generated by machine learning in the first learning phase 101.

The element 103c estimates the surface state of the grinding wheel 16 using the estimation input data and the second learning model and determines whether truing of the grinding wheel 16 is to be executed, whether dressing of the grinding wheel 16 is to be executed, and whether replacement of the grinding wheel 16 is to be executed based on the estimated surface state of the grinding wheel 16. The second learning model which is used by the element 103c is the second learning model which is generated by machine learning in the first learning phase 101.

An update phase 104 corresponding to process (f) will be described below. The machine learning device 100 includes an element 104a that acquires update input data, and an element 104b that updates the operation command data, as elements functioning in the update phase 104 that updates the operation command data. The update input data which is acquired by the element 104a is the same kind of data as the second learning input data and is data which is acquired with regard to a workpiece W (a new workpiece W) other than the workpiece W which has been used for learning.

The element 104b updates the operation command data using the update input data, the third learning model, the estimated grinding quality, and the estimated surface state of the grinding wheel 16. The third learning model which is used by the element 104b is the third learning model which is generated by machine learning in the second learning phase 502. The estimated grinding quality is grinding quality which is estimated in the estimation phase 102. The estimated surface state of the grinding wheel 16 is the surface state of the grinding wheel 16 which is estimated in the estimation phase 102.

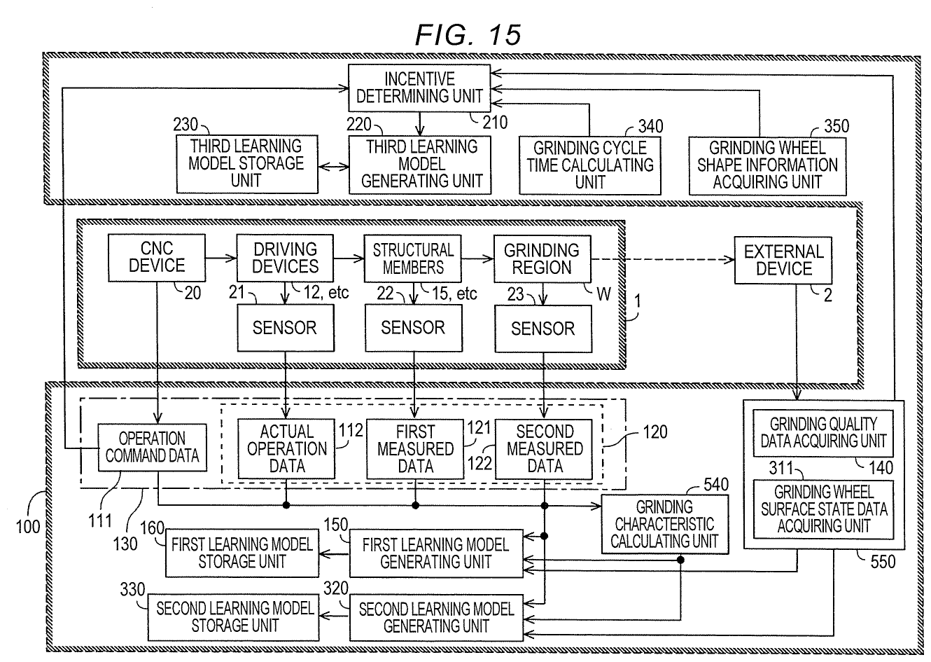

The detailed configuration of the first learning phase 101 of the machine learning device 100 will be described below with reference to FIG. 15. The configuration of the first learning phase 101 is included in a grinding-relevant learning model generating device. The configuration of the first learning phase 101 includes a first input data acquiring unit 130, a grinding characteristic calculating unit 540, a supervision data acquiring unit 550, a first learning model generating unit 150, a first learning model storage unit 160, a second learning model generating unit 320, and a second learning model storage unit 330.

The first learning input data, the first supervision data, and the second supervision data which are used in the first learning phase 101 are described in Table 5.

TABLE 5

| | Data | Sensor, | |
|---|---|---|---|
| | classification | measurer, | |
| | name | and others | Data name |
| First | Operation | | Command cutting |
| learning | command | | speed |
| input data | data | | Command position |
| | | | Command rotation |
| | | | speed of grinding |
| | | | wheel |
| | | | Command rotation |
| | | | speed of workpiece |
| | | | Coolant supply |
| | | | information |
| | Actual | Current | Drive current of motor |
| | operation | sensor | |
| | data | Position | Actual position of |
| | | sensor | motor |
| | First measured | Vibration | Vibration of structural |
| | data (structural | sensor | member |
| | member | Strain sensor | Deformation of |
| | state data) | | structural member |
| | Second measured | Sizing device | Size of workpiece |
| | data | Temperature | Grinding point |
| | (grinding region | sensor | temperature |
| | data) | | |
| | Value indicating | | Sharpness |
| | grinding | | Dynamic pressure of |
| | characteristics | | coolant |
| | | | Static rigidity of |
| | | | workpiece |
| First | Grinding quality | Affected layer | Affected layer data |
| supervision | data | detector | |
| data | | Surface quality | Surface quality data |
| | | measurer | |
| | | Chatter mark | Chatter mark data |
| | | detector | |
| Second | Grinding wheel | Affected layer | First surface state data |
| supervision | surface state data | detector | (corresponding to |
| data | | | affected layer) |
| | | Surface quality | Second surface state |
| | | measurer | data (corresponding to |
| | | | surface quality) |
| | | Chatter mark | Third surface state |
| | | detector | data (corresponding |
| | | | to chatter mark) |

The first input data acquiring unit 130 includes an operation command data acquiring unit 111 and a sampling data acquiring unit (a measured data acquiring unit) 120. The operation command data acquiring unit 111 acquires operation command data for the control device 20, as the first learning input data for machine learning. As described in Table 5, the operation command data includes a command cutting speed for each process, command positions of moving objects 14 and 15 at the time of switching the processes, a command rotation speed of the grinding wheel 16, a command rotation speed of a workpiece W, and coolant supply information. Here, grinding of a workpiece W is performed, for example, through a plurality of grinding processes such as rough grinding, accurate grinding, fine grinding, and spark-out.

The sampling data acquiring unit 120 acquires a plurality of kinds of sampling data in a predetermined period with regard to a plurality of workpieces W, as the first learning input data for machine learning. Sampling data is a data group in the predetermined sampling period for each workpiece W. The sampling data acquiring unit 120 includes an actual operation data acquiring unit 112 that acquires actual operation data on the driving devices 12a, etc. which are controlled by the control device 20 from the sensor 21, a first measured data acquiring unit 121 that acquires first measured data from the sensor 22, and a second measured data acquiring unit 122 that acquires second measured data from the sensor 23.

As described in Table 5, the actual operation data includes drive currents of the motors 12a, etc. and actual positions of the motors 12a, etc. The actual operation data acquiring unit 112 acquires actual operation data in the predetermined period for each workpiece W. The predetermined period is, for example, a period from a grinding start to a grinding end or a period from a rough grinding start to a rough grinding end. Since grinding is unstable in a non-steady state, data may be acquired in only a steady state.

The first measured data is data measured when grinding of a workpiece W is performed using the grinding wheel 16, and examples of the first measured data include vibration of the structural members 15, etc. and deformation (i.e., deformation amounts) of the structural members 15, etc. The second measured data is data measured when grinding of a workpiece W is performed using the grinding wheel 16, and examples of the second measured data include a size (a diameter) of the workpiece W and a grinding point temperature.

The first measured data acquiring unit 121 acquires the first measured data in the predetermined period for each workpiece W. The second measured data acquiring unit 122 also acquires the second measured data in the predetermined period for each workpiece W. The first measured data and the second measured data are acquired in the same predetermined period as the predetermined period in which the actual operation data is acquired. As described above, the predetermined period is, for example, a period from a grinding start to a grinding end or a period from a rough grinding start to a rough grinding end.

A grinding characteristic calculating unit 540 calculates a value indicating grinding characteristics based on the operation command data and the sampling data which are acquired by the first input data acquiring unit 130. Particularly, the grinding characteristic calculating unit 540 calculates the value indicating grinding characteristics based on a plurality of kinds of sampling data. The value indicating grinding characteristics is the first learning input data, as well as the operation command data and the sampling data as described in Table 5.

For example, the grinding characteristic calculating unit 540 calculates the value indicating grinding characteristics by expressing a relationship between a plurality of kinds of sampling data in the predetermined period using an approximate relational expression. The approximate relational expression is expressed, for example, by two kinds of parameters and is a relatively low order relational expression such as a linear expression, a quadratic expression or a cubic expression. The approximate relational expression may be expressed by three or more kinds of parameters.

The value indicating grinding characteristics is a differential value, an extremal value, or a value in which a predetermined axial component is zero in the approximate relational expression. For example, when the approximate relational expression is expressed as a linear expression based on two kinds of sampling data, the value indicating grinding characteristics is a slope (a differential value) of the linear approximate relational expression. That is, the sampling data is a data group in the predetermined period and the value indicating grinding characteristics is one numerical value. The value indicating grinding characteristics is data which is arranged based on the sampling data unlike the sampling data which is a data group (a group of a plurality of pieces of data).

Specific examples of the value indicating grinding characteristics include sharpness of the grinding wheel 16, a dynamic pressure of a coolant which is supplied to a grinding point, and static rigidity of a workpiece W. As the value indicating grinding characteristics, one of the three kinds may be employed or all of the three kinds may be employed. A kind of value other than the above-described three kinds may be included in the value indicating grinding characteristics.

The sharpness of the grinding wheel 16 and the dynamic pressure of a coolant are indices indicating the state of the grinding wheel 16. The sharpness of the grinding wheel 16 is a value which is obtained from a relationship between two kinds of sampling data (a data group) in a two-dimensional coordinate system with grinding resistance and an amount of cutting per unit time (per rotation of a workpiece W) as parameters. The sharpness of the grinding wheel 16 may be obtained using a removed volume of a workpiece W per unit time (per rotation of a workpiece W) as a parameter instead of the amount of cutting.

The dynamic pressure of a coolant can be obtained using the same parameter as the parameters used to obtain the sharpness of the grinding wheel 16. That is, the dynamic pressure of a coolant is a value which is obtained from a relationship between two kinds of sampling data (a data group) in a two-dimensional coordinate system with grinding resistance and an amount of cutting per unit time (per rotation of a workpiece W) as parameters. The dynamic pressure of a coolant may be obtained using a removed volume of a workpiece W per unit time (per rotation of a workpiece W) as a parameter instead of the amount of cutting.

The static rigidity of a workpiece W is a value which is obtained from a relationship between two kinds of sampling data (a data group) in a two-dimensional coordinate system with grinding resistance and an amount of warpage of a workpiece W as parameters. The amount of warpage of a workpiece W can be acquired from a feed position of the grinding wheel 16 or a diameter of the workpiece W. Here, when the workpiece W has a complicated shape, such as a crank shaft, static rigidity of the crank shaft in grinding of a crank pin can be obtained.

A supervision data acquiring unit 550 includes a grinding quality data acquiring unit 140 that acquires grinding quality data, and a grinding wheel surface state data acquiring unit 311 that acquires surface state data on the grinding wheel 16.

The grinding quality data acquiring unit 140 acquires grinding quality data on a plurality of workpieces W acquired by the external device 2, as first supervision data of supervised learning. That is, the grinding quality data acquiring unit 140 acquires, for example, affected layer data (data associated with a grinding burn mark and a softened layer due to grinding), surface quality data (data on, for example, surface roughness), and chatter mark data as the first supervision data.

The grinding wheel surface state data acquiring unit 311 acquires surface state data on the grinding wheel 16 after grinding is performed on each workpiece W, as second supervision data for machine learning. The grinding wheel surface state data acquiring unit 311 acquires the surface state data on the grinding wheel 16 corresponding to the grinding quality data on a workpiece W acquired by the external device 2.

The surface state data on the grinding wheel 16 includes first surface state data corresponding to a state of an affected layer of a workpiece W, second surface state data corresponding to surface quality of the workpiece W, and third surface state data corresponding to a state of a chatter mark of the workpiece W. The first surface state data may be affected layer data itself or may be data which is calculated based on the affected layer data. The second surface state data may be surface quality data itself of the workpiece W or may be data which is calculated based on the surface quality data. The third surface state data may be chatter mark data itself or may be data which is calculated based on the chatter mark data.

The first learning model generating unit 150 generates the first learning model by performing supervised learning. Specifically, the first learning model generating unit 150 acquires the operation command data and the sampling data acquired by the first input data acquiring unit 130 and the value indicating grinding characteristics calculated by the grinding characteristic calculating unit 540, as first learning input data. The first learning model generating unit 150 acquires grinding quality data on a plurality of workpieces W acquired by the grinding quality data acquiring unit 140, as the first supervision data. Then, the first learning model generating unit 150 generates the first learning model for estimating the grinding quality of a workpiece W by machine learning using the first learning input data and the first supervision data.

That is, the first learning model generating unit 150 generates the first learning model by machine learning using the operation command data, the actual operation data, the first measured data, the second measured data, and the value indicating grinding characteristics as the first learning input data, and using the grinding quality data as the first supervision data. The first learning model is a model indicating a relationship between the first learning input data and the first supervision data.

Here, the actual operation data, the first measured data, and the second measured data which are sampling data are data in a data group in the predetermined period for each workpiece W. Accordingly, the sampling data on only one workpiece W is a large amount of data. Sampling data on a plurality of workpieces W is an extremely large amount of data. However, the first learning model can be easily generated using the machine learning even when a large amount of sampling data on a plurality of workpieces W is used. Accordingly, by generating the first learning model in consideration of a large amount of sampling data that affects the grinding quality of a workpiece W, it is possible to acquire grinding quality of a workpiece W, which will be described later.

Since the sampling data in the predetermined period is a data group (a group of a plurality of pieces of data), there is a possibility that the sampling data may be affected by various factors. Therefore, the first learning input data includes the value indicating grinding characteristics which is calculated from the sampling data in the predetermined period in addition to the sampling data in the predetermined period. The value indicating grinding characteristics is data which is arranged based on the sampling data. It is difficult to directly measure the value indicating grinding characteristics.

That is, the first learning model is generated using the sampling data itself and the arranged value indicating grinding characteristics. By using the arranged value indicating grinding characteristics in this way, the first learning model is a model in which a relationship with grinding characteristics is emphasized. Accordingly, when grinding quality is estimated, the estimated grinding quality is a result obtained by fully considering grinding characteristics and is a result with higher accuracy. Grinding characteristics which are difficult to directly measure are acquired by calculation from sampling data. By using grinding characteristics, which are difficult to directly measure, as learning data, it is possible to obtain grinding quality with higher accuracy.

The first learning model is a model for estimating, for example, an affected layer state of a workpiece W, surface quality of the workpiece W, and a chatter mark state of the workpiece W as grinding quality of the workpiece W. Here, the first learning model is not limited to a case in which all kinds of the grinding quality are estimated, and only one or some kinds of the grinding quality may be estimated. The first learning model which is generated by the first learning model generating unit 150 is stored in the first learning model storage unit 160.

When the predetermined period in which data is acquired is a period from a grinding start to a grinding end, the first learning model is a model in which all grinding processes are considered. On the other hand, when the predetermined period is, for example, a period from a rough grinding start to a rough grinding end, the first learning model is a learning model in which only a rough grinding process is considered. When it is required to specify processes that affect the grinding quality, the first learning model may be acquired for each process.

The second learning model generating unit 320 generates the second learning model by performing supervised learning. Specifically, the second learning model generating unit 320 acquires the operation command data and the sampling data acquired by the first input data acquiring unit 130 and the value indicating grinding characteristics calculated by the grinding characteristic calculating unit 540, as first learning input data. The second learning model generating unit 320 acquires surface state data on the grinding wheel 16 for each workpiece W acquired by the grinding wheel surface state data acquiring unit 311, as the second supervision data. Then, the second learning model generating unit 320 generates the second learning model for estimating the surface state of the grinding wheel 16 by machine learning using the first learning input data and the second supervision data.

That is, the second learning model generating unit 320 generates the second learning model by machine learning using the operation command data, the actual operation data, the first measured data, the second measured data, and the value indicating grinding characteristics as the first learning input data, and using the grinding wheel surface state data as the second supervision data. The second learning model is a model indicating a relationship between the first learning input data and the second supervision data. Even when there are a plurality of pieces of sampling data, the second learning model can be generated using the machine learning. By using the arranged value indicating grinding characteristics, the second learning model is a model in which a relationship with grinding characteristics is emphasized. As a result, when the surface state of the grinding wheel 16 is estimated, the estimated surface state is a result obtained by fully considering grinding characteristics, and is a result with higher accuracy.

The second learning model is a model for estimating an extent to which grinding quality of a workpiece is affected, as the surface state of the grinding wheel 16. The second learning model is a model for estimating a state in which dulling, clogging, breaking (shedding of abrasive grains), or the like occurs in the grinding wheel 16, a state in which excessive dressing has been performed on the grinding wheel 16, or the like, as the surface state of the grinding wheel 16.

For example, the second learning model is a model for estimating a first surface state corresponding to an affected layer state of a workpiece W, a second surface state corresponding to surface quality of the workpiece W, and a third surface state corresponding to a chatter mark state of the workpiece W, as the surface state of the grinding wheel 16. Here, the second learning model is not limited to a case in which all the surface states are estimated, and one or some of the surface states may be estimated. The second learning model which is generated by the second learning model generating unit 320 is stored in the second learning model storage unit 330.

The detailed configuration of the second learning phase 502 of the machine learning device 100 will be described below with reference to FIG. 15. The configuration of the second learning phase 502 includes an operation command data acquiring unit 111, a grinding quality data acquiring unit 140, a grinding wheel surface state data acquiring unit 311, a grinding cycle time calculating unit 340, a grinding wheel shape information acquiring unit 350, an incentive determining unit 210, a third learning model generating unit 220, and a third learning model storage unit 230.

The second learning input data, the first evaluation result data, and the second evaluation result data which are used in the second learning phase 502 are described in Table 6.

TABLE 6

| | Data | | |
|---|---|---|---|
| | classification | Sensor, | |
| | name | measurer | Data name |
| Second | Operation | | Command cutting |
| learning | command | | speed |
| input data | data | | Command position |
| | | | Command rotation |
| | | | speed of grinding |
| | | | wheel |
| | | | Command rotation |
| | | | speed of workpiece |
| | | | Coolant supply |
| | | | information |
| First | Grinding quality | Affected layer | Affected layer data |
| evaluation | data | detector | |
| result data | | Surface quality | Surface quality data |
| | | measurer | |
| | | Chatter mark | Chatter mark data |
| | | detector | |
| Second | Grinding wheel | Affected layer | First surface state data |
| evaluation | surface state data | detector | (corresponding to |
| result data | | | affected layer) |
| | | Surface quality | Second surface state |
| | | measurer | data (corresponding to |
| | | | surface quality) |
| | | Chatter mark | Third surface state |
| | | detector | data (corresponding |
| | | | to chatter mark) |

The operation command data acquiring unit 111 acquires operation command data on a plurality of workpieces W, as second learning input data for machine learning. The grinding quality data acquiring unit 140 acquires grinding quality data on the plurality of workpieces W as first evaluation result data for machine learning. The grinding wheel surface state data acquiring unit 311 acquires surface state data on the grinding wheel 16 after grinding is performed on each workpiece W, as second evaluation result data for machine learning. Here, as described in Table 6, the second learning input data includes a plurality of pieces of data, but not all pieces of data described in Table 6 need to be used, and only some pieces of data may be used.

The grinding cycle time calculating unit 340 calculates a grinding cycle time for one workpiece W. The grinding cycle time is a value obtained by dividing the sum of the time required for grinding a plurality of workpieces W, the time required for replacement of the grinding wheel 16 in the grinding, the time required for dressing of the grinding wheel 16 in the grinding, and the time required for truing of the grinding wheel 16 in the grinding by the number of workpieces W. That is, as the number of times of replacement of the grinding wheel 16 decreases, as the number of times of dressing of the grinding wheel 16 decreases, and as the number of times of truing of the grinding wheel 16 decreases, the grinding cycle time decreases.

A grinding wheel shape information acquiring unit 350 acquires shape information on the grinding wheel 16. The grinding wheel shape information acquiring unit 350 acquires a size (a diameter) of the grinding wheel 16 which is measured by the grinding wheel truing device 18. That is, the grinding wheel shape information acquiring unit 350 acquires the shape information when truing or dressing of the grinding wheel 16 is performed by the grinding wheel truing device 18. The grinding wheel shape information acquiring unit 350 can acquire size change of the grinding wheel 16 and deformation of the grinding wheel 16 as the shape information on the grinding wheel 16.

The incentive determining unit 210 acquires the operation command data which is the second learning input data, the grinding quality data which is the first evaluation result data, and the surface state data on the grinding wheel 16 which is the second evaluation result data, and determines an incentive for the operation command data based on the grinding quality data and the surface state data. Here, the incentive is an incentive for a combination of operation command data in reinforcement learning.

In the incentive determining unit 210, a high incentive is given to operation command data when the grinding quality data corresponding to the operation command data causes a desirable result, and a low incentive (including a minus incentive) is given to operation command data when the grinding quality data corresponding to the operation command data causes an undesirable result.

For example, the incentive determining unit 210 increases the incentive when there is no affected layer in the affected layer data on a workpiece W and decreases the incentive when there is an affected layer. The incentive determining unit 210 increases the incentive when the surface quality data on a workpiece W is equal to or less than a predetermined threshold value and decreases the incentive when the surface quality data is greater than the predetermined threshold value. The incentive determining unit 210 increases the incentive when there is no chatter mark in the chatter mark data on a workpiece W and decreases the incentive when there is a chatter mark. The incentive determining unit 210 may determine the incentive based on all of the affected layer data, the surface quality data, and the chatter mark data or may determine the incentive based on only one or some of them.

In the incentive determining unit 210, a high incentive is given to operation command data when the surface state data corresponding to the operation command data causes a desirable result, and a low incentive is given to operation command data when the surface state data corresponding to the operation command data causes an undesirable result.

For example, the incentive determining unit 210 increases the incentive when there is no affected layer corresponding to the first surface state data, and decreases the incentive when there is an affected layer. The incentive determining unit 210 increases the incentive when the surface quality data on a workpiece W corresponding to the second surface state data is equal to or less than a predetermined threshold value and decreases the incentive when the surface quality data is greater than the predetermined threshold value. The incentive determining unit 210 increases the incentive when there is no chatter mark corresponding to the third surface state data, and decreases the incentive when there is a chatter mark.

The incentive determining unit 210 acquires the grinding cycle time which is calculated by the grinding cycle time calculating unit 340 and determines the incentive for the operation command data based on the grinding cycle time. Specifically, the incentive determining unit 210 increases the incentive as the grinding cycle time decreases. That is, the incentive determining unit 210 increases the incentive as at least one of the time required for replacement of the grinding wheel 16, the time required for dressing of the grinding wheel 16, and the time required for truing of the grinding wheel 16 decreases.

The incentive determining unit 210 determines the incentive based on the shape information on the grinding wheel 16 which is acquired by the grinding wheel shape information acquiring unit 350. Specifically, the incentive determining unit 210 increases the incentive as the size change of the grinding wheel 16 decreases and as the deformation of the grinding wheel 16 decreases.

The third learning model generating unit 220 generates the third learning model for adjusting the operation command data to increase the incentive by machine learning. In the third learning model generating unit 220, for example, Q learning, Sarsa, or a Monte Carlo method is applied as the reinforcement learning.

Here, it is assumed that the operation command data before being adjusted is data on a first workpiece W and the operation command data after being adjusted is data on a second workpiece W. A relationship between the operation command data on the first workpiece W and the grinding quality data on the first workpiece W is referred to as a first data relationship. A relationship between the operation command data on the second workpiece W and the grinding quality data on the second workpiece W is referred to as a second data relationship.

The third learning model is a model indicating a correlation between the first data relationship before adjustment and the second data relationship after adjustment. The third learning model generating unit 220 learns a method of adjustment from the operation command data on the first workpiece W before being adjusted (i.e., the operation command data on the first workpiece W before adjustment) to the operation command data on the second workpiece W after being adjusted (i.e., the operation command data on the second workpiece W after adjustment) such that the grinding quality data on the second workpiece W after adjustment is better than the grinding quality data on the first workpiece W before adjustment, that is, such that the incentive increases.

The adjusted operation command data is obtained by adjusting the unadjusted operation command data within a preset range of limitation. For example, regarding the command cutting speed which is one adjustable parameter, the command cutting speed after being adjusted is limited to a range based on a predetermined rate (for example, ±3%) with respect to the command cutting speed before being adjusted. The predetermined rate can be set to any rate. The same applies to other adjustable parameters. Other adjustable parameters can be set. The generated third learning model is stored in the third learning model storage unit 230.

In the third learning model, the surface state data on the grinding wheel 16 is used similarly to the grinding quality data. That is, the third learning model generating unit 220 learns a method of adjustment from the operation command data on the first workpiece W before being adjusted to the operation command data on the second workpiece W after being adjusted such that the surface state data on the grinding wheel 16 when grinding of the second workpiece W after adjustment has been performed is better than the surface state data on the grinding wheel 16 when grinding of the first workpiece W before adjustment has been performed, that is, such that the incentive increases.

The third learning model generating unit 220 can also generate the third learning model in the update phase 104 which will be described later. In this case, the grinding quality data which is acquired by the estimation phase 102 is used as the grinding quality data which is the first evaluation result data. The surface state data which is acquired by the estimation phase 102 is used as the surface state data on the grinding wheel 16 which is the second evaluation result data.

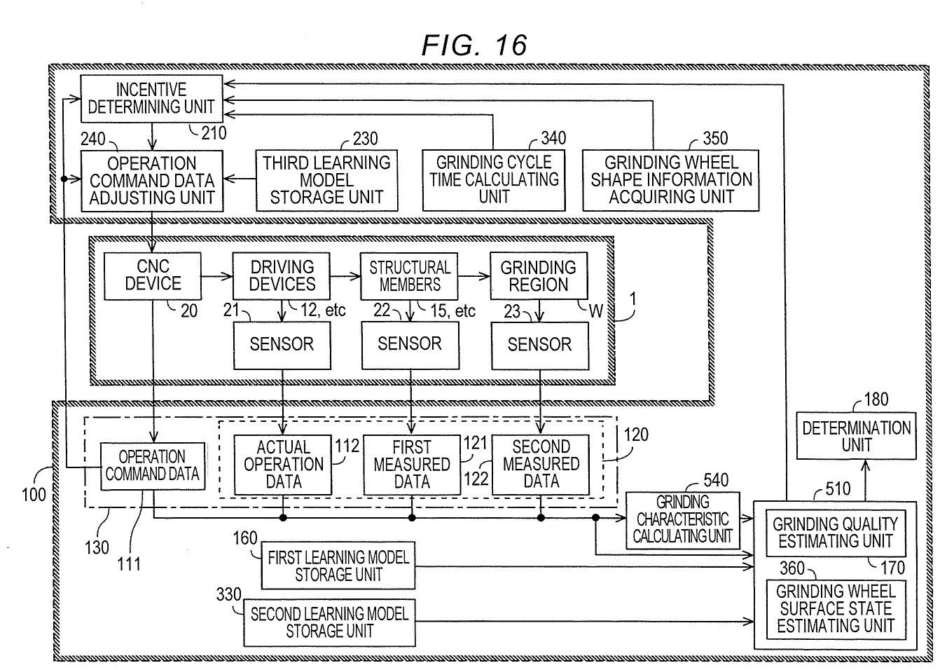

The detailed configuration of the estimation phase 102 of the machine learning device 100 will be described below with reference to FIG. 16. The configuration of the estimation phase 102 corresponds to an estimation device associated with grinding. The configuration of the estimation phase 102 includes a first input data acquiring unit 130, a first learning model storage unit 160, a second learning model storage unit 330, an estimation unit 510, and a determination unit 180.

The estimation unit 510 includes a grinding quality estimating unit 170 and a grinding wheel surface state estimating unit 360. The grinding quality estimating unit 170 acquires first input data in the predetermined period during grinding of a new workpiece W and the value indicating grinding characteristics which is calculated by the grinding characteristic calculating unit 540 as estimation input data. That is, the estimation input data includes the operation command data, the sampling data, and the value indicating grinding characteristics. The grinding quality estimating unit 170 estimates the grinding quality of the new workpiece W by receiving the estimation input data, and using the first learning model which is stored in the first learning model storage unit 160.

Here, the first learning model is a model indicating the relationship between the first learning input data and the first supervision data as described above. In the first learning model, the grinding quality data which is the first supervision data includes an affected layer state of a workpiece W, surface quality of the workpiece W, and a chatter mark state of the workpiece W.

Therefore, the grinding quality estimating unit 170 estimates an affected layer state of a workpiece W, surface quality of the workpiece W, and a chatter mark state of the workpiece WI, as the grinding quality. The grinding quality estimating unit 170 may estimate only one or some kinds of grinding quality instead of estimating all kinds of grinding quality. For example, the grinding quality estimating unit 170 may estimate only the affected layer state. In this case, the first learning model is generated as a model for estimating only the affected layer state.

The first learning model is generated using the sampling data and the arranged value indicating grinding characteristics. By using the arranged value indicating grinding characteristics, the first learning model becomes a model in which a relationship with grinding characteristics is emphasized. Accordingly, when grinding quality is estimated, the estimated grinding quality is a result obtained by fully considering grinding characteristics and is a result with higher accuracy.

The grinding wheel surface state estimating unit 360 acquires the first input data in the predetermined period during grinding of a new workpiece W and the value indicating grinding characteristics calculated by the grinding characteristic calculating unit 540, as estimation input data. That is, the estimation input data includes the operation command data, the sampling data, and the value indicating grinding characteristics. The grinding wheel surface state estimating unit 360 estimates the surface state of the grinding wheel 16 when grinding of a new workpiece W is performed, by receiving the estimation input data and using the second learning model which is stored in the second learning model storage unit 330. Here, the second learning model is a model indicating the relationship between the first learning input data and the second supervision data as described above.

Therefore, the grinding wheel surface state estimating unit 360 estimates an extent to which grinding quality of a workpiece W is affected, as the surface state of the grinding wheel 16. For example, the grinding wheel surface state estimating unit 360 estimates a first surface state corresponding to an affected layer state of the workpiece W, a second surface state corresponding to surface quality of the workpiece W, and a third surface state corresponding to a chatter mark state of the workpiece W, as the surface state of the grinding wheel 16. Here, the grinding wheel surface state estimating unit 360 may estimate one or some surface states instead of estimating all the surface states of the grinding wheel 16. For example, the grinding wheel surface state estimating unit 360 may estimate only the first surface state. In this case, the second learning model is generated as a model for estimating only the first surface state.

The second learning model is generated using the sampling data itself and the arranged value indicating grinding characteristics. By using the arranged value indicating grinding characteristics, the second learning model becomes a model in which a relationship with grinding characteristics is emphasized. Accordingly, the estimated surface state of the grinding wheel 16 is a result obtained by fully considering the grinding characteristics and is a result with higher accuracy.

The determination unit 180 determines whether a workpiece W is non-defective or defective based on the grinding quality of the workpiece W which is estimated by the grinding quality estimating unit 170. For example, when it is determined based on the estimated affected layer state that there is an affected layer in a workpiece W (a predetermined condition has not been satisfied), the determination unit 180 determines that the workpiece W is defective. When it is determined that the estimated surface quality has not satisfied a predetermined condition, the determination unit 180 determines that the workpiece W is defective. When it is determined based on the estimated chatter mark state that there is a chatter mark (a predetermined condition has not been satisfied), the determination unit 180 determines that the workpiece W is defective.

On the other hand, when the affected layer state, the surface quality, and the chatter mark state of a workpiece W satisfy the corresponding conditions, the determination unit 180 determines that the workpiece W is non-defective. In this way, by using the first learning model which is generated by machine learning, it is possible to easily perform determination regarding a plurality of conditions.

The determination unit 180 determines at least one of i) whether truing of the grinding wheel 16 is to be executed, ii) whether dressing of the grinding wheel 16 is to be executed, and iii) whether replacement of the grinding wheel 16 is to be executed, based on the surface state of the grinding wheel 16 which is estimated by the grinding wheel surface state estimating unit 360. For example, when it is determined based on the first surface state corresponding to the estimated affected layer state that there is an affected layer in a workpiece W (a predetermined condition has not been satisfied), the determination unit 180 determines that dressing of the grinding wheel 16 is to be executed. When it is determined that the second surface state corresponding to the estimated surface quality has not satisfied a predetermined condition, the determination unit 180 determines that truing of the grinding wheel 16 is to be executed. When it is determined based on the third surface state corresponding to the estimated chatter mark state that there is a chatter mark (a predetermined condition has not been satisfied), the determination unit 180 determines that dressing of the grinding wheel 16 is to be executed.

On the other hand, when the first surface state, the second surface state, and the third surface state have satisfied the corresponding conditions, the determination unit 180 determines that the grinding wheel 16 is in a good state. In this case, it is determined that dressing and truing of the grinding wheel 16 do not need to be executed. By using the second learning model which is generated by machine learning in this way, it is possible to easily perform determination regarding a plurality of conditions.

The detailed configuration of the update phase 104 of the machine learning device 100 will be described below with reference to FIG. 16. The configuration of the update phase 104 corresponds to an operation command data updating device associated with grinding. The configuration of the update phase 104 includes an operation command data acquiring unit 111, a grinding quality estimating unit 170, a grinding wheel surface state estimating unit 360, a grinding cycle time calculating unit 340, a grinding wheel shape information acquiring unit 350, an incentive determining unit 210, a third learning model storage unit 230, and an operation command data adjusting unit 240.

The operation command data acquiring unit 111 acquires data on grinding of a new workpiece W, and is substantially the same as the operation command data acquiring unit 111 described in the second learning phase 502. The grinding cycle time calculating unit 340 and the grinding wheel shape information acquiring unit 350 are also substantially the same as those described in the second learning phase 502. The grinding quality estimating unit 170 and the grinding wheel surface state estimating unit 360 are the same as those described in the estimation phase 102. That is, the grinding quality estimating unit 170 and the grinding wheel surface state estimating unit 360 estimate the grinding quality of a workpiece W and the surface state of the grinding wheel 16 with regard to grinding of the new workpiece W.

The incentive determining unit 210 determines an incentive using the operation command data, the grinding quality, and the surface state of the grinding wheel 16 which are acquired in grinding of the new workpiece W. That is, the incentive determining unit 210 determines an incentive for the operation command data based on the grinding quality and the surface state of the grinding wheel 16 with regard to grinding of the new workpiece W. The incentive determining unit 210 determines an incentive for the operation command data based on the grinding cycle time and the shape information on the grinding wheel 16. The third learning model storage unit 230 stores the third learning model which is generated by the third learning model generating unit 220 as described in the second learning phase 502.

The operation command data adjusting unit 240 determines a method of adjusting operation command data using the operation command data for grinding of a new workpiece W, the estimated grinding quality of the new workpiece W, the estimated surface state of the grinding wheel 16 when grinding of the new workpiece W is performed, the incentive, and the third learning model, and adjusts the operation command data based on the determined adjustment method. Here, the third learning model is a model which is generated by learning the method of adjustment from the operation command data before being adjusted to the operation command data after being adjusted to increase the incentive.

Specifically, the operation command data adjusting unit 240 acquires current operation command data as operation command data before being adjusted, and acquires an incentive at that time. In this case, the operation command data adjusting unit 240 determines target operation command data to which the current operation command data is adjusted, with the use of the current operation command data, the incentive for the current operation command data, and the third learning model. That is, the target operation command data is operation command data for which the incentive higher than the incentive for the current operation command data is provided.

In the process performed by the operation command data adjusting unit 240, a plurality of candidates of the target operation command data with the same incentive may be output. In this case, the operation command data adjusting unit 240 can rank the plurality of candidates, for example, by setting priorities for parameters to be adjusted. For example, when the priorities are set for the parameters to be adjusted, the first priority may be given to the command cutting speed and the second priority may be given to the command rotation speed of a workpiece W.

Then, the operation command data adjusting unit 240 determines that the candidate at the first rank should be the target operation command data, and updates the current operation command data to the target operation command data. Then, the grinding machine 1 performs grinding of a workpiece W based on the updated operation command data. In the update phase 104 of the machine learning device 100, the operation command data in next grinding is adjusted again based on data on grinding of the workpiece W. A frequency of adjustment of the operation command data may be set. For example, the operation command data may be adjusted after grinding of a preset number of workpieces W is performed.

That is, the operation command data is updated using the third learning model which is generated by machine learning of the machine learning device 100. Accordingly, even when a grinding state changes, the operation command data is updated based on a current grinding state. By updating the operation command data in this way, it is possible to improve the grinding quality of a workpiece W.

By updating the operation command data, it is possible to perform grinding based on the surface state of the grinding wheel 16. That is, by updating the operation command data, the surface state of the grinding wheel 16 is improved. When the surface state of the grinding wheel 16 is improved, it is possible to improve the grinding quality of a workpiece W. By updating the operation command data, the time required for replacement of the grinding wheel 16, the time required for dressing of the grinding wheel 16, and the time required for truing of the grinding wheel 16 decrease. As a result, the grinding cycle time is shortened. By updating the operation command data, it is possible to decrease size change of the grinding wheel 16 and to decrease deformation of the grinding wheel 16.

Particularly, in the update phase 104, processes are performed using the grinding quality of a workpiece W and the surface state of the grinding wheel 16 which are estimated in the estimation phase 102. That is, the third learning model for adjusting the operation command data can be generated using the grinding quality or the surface state of the grinding wheel in which the grinding characteristics are satisfactorily reflected, and the operation command data can be updated. Accordingly, it is possible to appropriately update the operation command data based on the grinding quality of a workpiece W and the surface state of the grinding wheel.

The description has been provided on the case in which the machine learning device 100 performs all of generation of the first learning model, generation of the second learning model, estimation of the grinding quality of a workpiece W, determination as to whether a workpiece W is non-defective or defective, estimation of the surface state of the grinding wheel 16, determination as to whether truing of the grinding wheel 16 is to be executed, determination as to whether dressing of the grinding wheel 16 is to be executed, determination as to whether replacement of the grinding wheel 16 is to be executed, and update of the operation command data. The machine learning device 100 may be employed as a device that performs only one or some of the above-mentioned processes. In this case, the machine learning device 100 includes only the configuration(s) corresponding to the process(es).

What is claimed is:

1. A grinding quality estimation model generating device comprising:
a measured data acquiring unit configured to acquire measured data in a predetermined period for each of a plurality of workpieces, the measured data being data measured when grinding of the workpiece is performed using a grinding wheel in a grinding machine, and the measured data being at least one of first measured data indicating a state of a structural member of the grinding machine and second measured data associated with a grinding region; and
a first learning model generating unit configured to generate a first learning model for estimating grinding quality of the workpiece by machine learning using the measured data associated with the plurality of workpieces as first learning input data.

2. The grinding quality estimation model generating device according to claim 1, wherein:
the measured data is at least one of actual operation data on a driving device of the grinding machine, the first measured data, and the second measured data;
the grinding quality estimation model generating device further comprises a grinding characteristic calculating unit configured to calculate a value indicating a grinding characteristic based on the measured data in the predetermined period; and
the first learning model generating unit is configured to generate the first learning model for estimating the grinding quality of the workpiece by the machine learning using the measured data in the predetermined period and the value indicating the grinding characteristic as the first learning input data.

3. The grinding quality estimation model generating device according to claim 1, wherein:
the measured data is at least one of actual operation data on a driving device of the grinding machine, the first measured data, and the second measured data; and
the grinding quality estimation model generating device further comprises a grinding characteristic calculating unit configured to calculate a value indicating a grinding characteristic based on the measured data in the predetermined period, and a second learning model generating unit configured to generate a second learning model for estimating a surface state of the grinding wheel by the machine learning using the measured data in the predetermined period and the value indicating the grinding characteristic as the first learning input data.

4. The grinding quality estimation model generating device according to claim 1, wherein:
the measured data acquiring unit is configured to acquire the first measured data which is at least one of vibration of the structural member of the grinding machine and a deformation amount of the structural member of the grinding machine, and the second measured data which is at least one of a size and a grinding point temperature of the workpiece that varies due to the grinding, as the measured data; and
the first learning model generating unit is configured to generate the first learning model by the machine learning using the first measured data and the second measured data associated with the plurality of workpieces, as the first learning input data.

5. The grin ding quality estimation model generating device according to claim 1, further comprising
a grinding quality data acquiring unit configured to acquire, for each of the plurality of workpieces, grinding quality data on the workpiece wherein
the first learning model generating unit is configured to generate the first learning model by the machine learning using the grinding quality data as supervision data.

6. The grinding quality estimation model generating device according to claim 5, wherein the grinding quality data on the workpiece is at least one of affected layer data on the workpiece, surface quality data on the workpiece, and chatter mark data on the workpiece.

7. The grinding quality estimation model generating device according to claim 1, further comprising
an operation-relevant data acquiring unit configured to acquire operation-relevant data in the predetermined period for each of the plurality of workpieces, the operation-relevant data being at least one of operation command data for a control device of the grinding machine and actual operation data on a driving device controlled by the control device, wherein
the first learning model generating unit is configured to generate the first learning model by the machine learning using the measured data on the plurality of workpieces and the operation-relevant data, as the first learning input data.

8. A grinding quality estimating device comprising:
the grinding quality estimation model generating device according to claim 1; and
a grinding quality estimating unit configured to estimate grinding quality of a new workpiece using the first learning model and estimation input data which is the measured data in the predetermined period during grinding of the new workpiece.

9. The grinding quality estimating device according to claim 8, wherein:
the first learning model generating unit is configured to generate the first learning model for estimating at least one of an affected layer state of the workpiece, surface quality of the workpiece, and a chatter mark state of the workpiece as the grinding quality of the workpiece, and the grinding quality estimating unit is configured to estimate at least one of the affected layer state of the workpiece, the surface quality of the workpiece, and the chatter mark state of the workpiece as the grinding quality of the new workpiece.

10. The grinding quality estimating device according to claim 8, further comprising a determination unit configured to determine whether the workpiece is non-defective or defective based on the grinding quality of the workpiece estimated by the grinding quality estimating unit.

11. A poor quality factor estimating device comprising:
the grinding quality estimating device according to claim 10;
a non-defective product processing data storage unit configured to store non-defective product processing data which is prepared based on actual operation data associated with a non-defective product and acquired in advance, or the measured data associated with the non-defective product and acquired in advance, the actual operation data being data on a driving device controlled by a control device of the grinding machine; and
a difference information extracting unit configured to compare the non-defective product processing data with defective product processing data which is the actual operation data or the measured data associated with the workpiece which has been determined to be a defective product by the determination unit, and to extract processing data difference information for identifying a poor quality factor that causes poor quality.

12. The poor quality factor estimating device according to claim 11, further comprising:
a relationship information storage unit configured to store factor relationship information indicating a relationship between the processing data difference information and the poor quality factor; and
a poor quality factor estimating unit configured to estimate the poor quality factor based on the relationship between the processing data difference information and the factor relationship information.

13. The poor quality factor estimating device according to claim 12, wherein the relationship information storage unit is configured to store a plurality of kinds of the factor relationship information indicating relationships between the processing data difference information and a plurality of kinds of the poor quality factors.

14. The poor quality factor estimating device according to claim 12, wherein the factor relationship information is a learning model which is generated by machine learning using the processing data difference information and the poor quality factor, as learning data.

15. The poor quality factor estimating device according to claim 11, wherein the poor quality factor is at least one of a condition for processing of the workpiece using the grinding machine, sharpness of the grinding wheel, and vibration of a constituent component of the grinding machine.

16. The poor quality factor estimating device according to claim 11, wherein the difference information extracting unit is configured to extract a difference between the non-defective product processing data and the defective product processing data, as the processing data difference information.

17. The poor quality factor estimating device according to claim 11, wherein the non-defective product processing data is prepared based on the measured data or the actual operation data associated with a plurality of the non-defective products and acquired in advance.

18. The poor quality factor estimating device according to claim 11, wherein:
the non-defective product processing data storage unit is configured to store a plurality of kinds of the non-defective product processing data; and
the difference information extracting unit is configured to compare the plurality of kinds of the non-defective product processing data with the defective product processing data, and to extract a plurality of kinds of the processing data difference information.

19. The grinding quality estimation model generating device according to claim 2, wherein the grinding characteristic calculating unit is configured to calculate the value indicating the grinding characteristic by expressing a relationship between a plurality of kinds of the measured data in the predetermined period using an approximate relational expression.

20. The grinding quality estimation model generating device according to claim 3, wherein the grinding characteristic calculating unit is configured to calculate the value indicating the grinding characteristic by expressing a relationship between a plurality of kinds of the measured data in the predetermined period using an approximate relational expression.

21. The grinding quality estimation model generating device according to claim 2, wherein the grinding characteristic calculating unit is configured to calculate at least one of sharpness of the grinding wheel, a dynamic pressure of a coolant which is supplied to a grinding point, and static rigidity of the workpiece, as the value indicating the grinding characteristic, based on the measured data in the predetermined period.

22. The grinding quality estimation model generating device according to claim 3, wherein the grinding characteristic calculating unit is configured to calculate at least one of sharpness of the grinding wheel, a dynamic pressure of a coolant which is supplied to a grinding point, and static rigidity of the workpiece, as the value indicating the grinding characteristic, based on the measured data in the predetermined period.

23. A grinding quality estimating device comprising:
a first learning model storage unit configured to store the first learning model which is generated by the grinding quality estimation model generating device according to claim 2; and
a grinding quality estimating unit configured to estimate grinding quality of a new workpiece using the first learning model, and estimation input data which is the measured data in the predetermined period during grinding of the new workpiece.

24. A grinding quality estimating device comprising:
a second learning model storage unit configured to store the second learning model which is generated by the grinding quality estimation model generating device according to claim 3; and
a surface state estimating unit configured to estimate the surface state of the grinding wheel when grinding of a new workpiece is performed, with use of the second learning model, and estimation input data which is the measured data in the predetermined period during grinding of the new workpiece.

25. A grinding machine operation command data updating device comprising:
an operation command data acquiring unit configured to acquire, for each of a plurality of workpieces, operation command data for a control device of a grinding machine when the grinding of the workpiece is performed using a grinding wheel in the grinding machine;
an incentive determining unit configured to determine, for each of the plurality of workpieces, an incentive for the operation command data based on grinding quality of the workpiece;
a third learning model generating unit configured to generate a third learning model for adjusting the operation command data to increase the incentive by machine learning using the operation command data associated with the plurality of workpieces and the incentive; and
an operation command data adjusting unit configured to adjust the operation command data using the operation command data associated with the grinding of a new workpiece, the grinding quality estimated by the grinding quality estimating device according to claim 23, the incentive, and the third learning model.

26. A grinding machine operation command data updating device comprising:
an operation command data acquiring unit configured to acquire, for each of a plurality of workpieces, operation command data for a control device of a grinding machine when the grinding of the workpiece is performed using a grinding wheel in the grinding machine;
an incentive determining unit configured to determine, for each of the plurality of workpieces, an incentive for the operation command data based on a surface state of the grinding wheel;
a third learning model generating unit configured to generate a third learning model for adjusting the operation command data to increase the incentive by machine learning using the operation command data associated with the plurality of workpieces and the incentive; and
an operation command data adjusting unit configured to adjust the operation command data using the operation command data associated with the grinding of a new workpiece, the surface state estimated by the grinding quality estimating device according to claim 24, the incentive, and the third learning model.

27. A grinding machine operation command data adjustment model generating device comprising:
an operation command data acquiring unit configured to acquire, for each of a plurality of workpieces, operation command data for a control device of a grinding machine when grinding of the workpiece is performed using a grinding wheel in the grinding machine;
a grinding quality data acquiring unit configured to acquire, for each of the plurality of workpieces, grinding quality data on the workpiece;
an incentive determining unit configured to determine, for each of the plurality of workpieces, an incentive for the operation command data based on the grinding quality data; and
a third learning model generating unit configured to generate a third learning model for adjusting the operation command data to increase the incentive by machine learning using the operation command data associated with the plurality of the workpieces and the incentive.

28. The grinding machine operation command data adjustment model generating device according to claim 27, wherein the grinding quality data on the workpiece is at least one of affected layer data on the workpiece, surface quality data on the workpiece, and chatter mark data on the workpiece.

29. The grinding machine operation command data adjustment model generating device according to claim 28, wherein the incentive determining unit is configured to increase the incentive when there is no affected layer and to decrease the incentive when there is an affected layer, based on the affected layer data on the workpiece.

30. The grinding machine operation command data adjustment model generating device according to claim 28, wherein the incentive determining unit is configured to increase the incentive when the surface quality data on the workpiece is equal to or less than a predetermined threshold value and to decrease the incentive when the surface quality data is greater than the predetermined threshold value.

31. The grinding machine operation command data adjustment model generating device according to claim 28, wherein the incentive determining unit is configured to increase the incentive when there is no chatter mark and to decrease the incentive when there is a chatter mark, based on the chatter mark data on the workpiece.

32. The grinding machine operation command data adjustment model generating device according to any one of claim 27, further comprising
a surface state data acquiring unit configured to acquire surface state data on the grinding wheel for each of the plurality of workpieces, wherein
the incentive determining unit is configured to determine, for each of the plurality of workpieces, the incentive for the operation command data based on the grinding quality data and the surface state data.

33. The grinding machine operation command data adjustment model generating device according to claim 32, wherein the surface state data on the grinding wheel is data that affects grinding quality of the workpiece.

34. The grinding machine operation command data adjustment model generating device according to claim 33, wherein the surface state data on the grinding wheel is at least one of first surface state data corresponding to an affected layer state of the workpiece, second surface state data corresponding to surface quality of the workpiece, and third surface state data corresponding to a chatter mark state of the workpiece.

35. The grinding machine operation command data adjustment model generating device according to any one of claim 27, wherein:
the grinding quality data on the workpiece is grinding quality which is estimated by a grinding quality estimating device;
the grinding quality estimating device includes a grinding quality estimation model generating device;
the grinding quality estimation model generating device includes a measured data acquiring unit configured to acquire measured data in a predetermined period for each of the plurality of workpieces, the measured data being data measured when grinding of the workpiece is performed using the grinding wheel in the grinding machine, and the measured data being at least one of first measured data indicating a state of a structural member of the grinding machine and second measured data associated with a grinding region, and the grinding quality estimation model generating device further includes a first learning model generating unit configured to generate a first learning model for estimating grinding quality of the workpiece by machine learning using the measured data associated with the plurality of workpieces as first learning input data; and
the grinding quality estimating device further includes a grinding quality estimating unit configured to estimate grinding quality of a new workpiece using the first learning model and estimation input data which is the measured data in the predetermined period during grinding of the new workpiece.

36. A grinding machine operation command data updating device comprising:
the grinding machine operation command data adjustment model generating device according to claim 27; and
an operation command data adjusting unit configured to adjust the operation command data using the operation command data associated with grinding of a new workpiece, the grinding quality data on the new workpiece, the incentive, and the third learning model.

37. The grinding machine operation command data updating device according to claim 36, further comprising a poor quality factor estimating device,
wherein the poor quality factor estimating device includes a grinding quality estimating device including a grinding quality estimation model generating device,
wherein the grinding quality estimation model generating device includes a measured data acquiring unit configured to acquire measured data in a predetermined period for each of the plurality of workpieces, the measured data being data measured when grinding of the workpiece is performed using the grinding wheel in the grinding machine, and the measured data being at least one of first measured data indicating a state of a structural member of the grinding machine and second measured data associated with a grinding region; and a first learning model generating unit configured to generate a first learning model for estimating grinding quality of the workpiece by machine learning using the measured data associated with the plurality of the workpieces as first learning input data,
wherein the grinding quality estimating device further includes a grinding quality estimating unit configured to estimate grinding quality of the new workpiece using the first learning model and estimation input data which is the measured data in the predetermined period during grinding of the new workpiece,
wherein the grinding quality estimating device further includes a determination unit configured to determine whether the workpiece is non-defective or defective based on the grinding quality of the workpiece estimated by the grinding quality estimating unit,
wherein the poor quality factor estimating device further includes a non-defective product processing data storage unit configured to store non-defective product processing data which is prepared based on actual operation data associated with a non-defective product and acquired in advance, or the measured data associated with the non-defective product and acquired in advance, the actual operation data being data on a driving device controlled by the control device of the grinding machine; a difference information extracting unit configured to compare the non-defective product processing data with defective product processing data which is the actual operation data or the measured data associated with the workpiece which has been determined to be a defective product by the determination unit, and to extract processing data difference information for identifying a poor quality factor that causes poor quality; a relationship information storage unit configured to store factor relationship information indicating a relationship between the processing data difference information and the poor quality factor; and a poor quality factor estimating unit configured to estimate the poor quality factor based on the relationship between the processing data difference information and the factor relationship information, and
wherein the operation command data adjusting unit is configured to further adjust the operation command data using the factor relationship information.
